(19) United States
(12) Patent Application Publication
(10) Pub. No.: US 2011/0219864 A1
(43) Pub. Date: Sep. 15, 2011

(54) TIRE CONDITION DETECTION DEVICE AND TIRE CONDITION DETECTION METHOD

(75) Inventors: Junichi Yukawa, Nara (JP); Hideki Nakata, Osaka (JP); Youichi Kurosawa, Kanagawa (JP)

(73) Assignee: PANASONIC CORPORATION, Osaka (JP)

(21) Appl. No.: 13/129,891

(22) PCT Filed: Sep. 29, 2010
(86) PCT No.: PCT/JP2010/005871

§ 371 Date: May 18, 2011

(30) Foreign Application Priority Data
Sep. 30, 2009 (JP) 2009-228279

(51) Int. Cl. B60C 23/02; G01M 17/02

(52) U.S. Cl. 73/146.3; 73/146

(57) ABSTRACT

Disclosed is a tire condition detection apparatus capable of detecting the condition of a tire with a high degree of precision. The tire condition detection apparatus detects the tire condition of a pneumatic tire fixed to a wheel, and has a vibration input section that inputs predetermined vibration to the tire, a frequency information acquisition section that acquires frequency information of the tire when the predetermined vibration is input, and a tire condition estimation section that extracts a resonance frequency of the tire from the acquired frequency information, and calculates a spring constant when the tire is modeled using an outer moment of inertia, an inner moment of inertia, and a spring constant of elastic force acting therebetween, from the extracted tire resonance frequency.

### TECHNICAL FIELD

The present invention relates to a tire condition detection apparatus and tire condition detection method for detecting a tire condition, such as internal pressure, of a tire of a vehicle.

### BACKGROUND ART

In recent years, there have been demands for improvements in vehicle safety, and research and development has been actively pursued in the field of elemental technologies that guarantee such safety. One of the elemental technologies that guarantee such safety is the detection of tire air pressure. A direct detection method and an indirect detection method are generally known as methods of detecting tire air pressure.

A direct detection method is a method whereby a sensor such as a pressure sensor is placed directly inside the wheel of a tire, and tire air pressure is detected based on pressure information acquired by this sensor. Pressure information acquired by the sensor is transmitted by radio, for example, from a transmitter placed inside the wheel of the tire to a receiver and a meter or suchlike indicator via an in-vehicle receiving antenna. A direct detection method enables tire air pressure to be measured with a high degree of precision, making detection possible even if the air pressure of all four tires falls simultaneously, for example.

However, this direct detection method involves high installation costs since the sensors are extremely expensive, and is therefore not widely used at present for tire air pressure detection. Another problem is that changing a wheel requires a sensor to be installed again, which entails further expense. Therefore, at the present time, an indirect detection method is generally used for tire air pressure detection for reasons of cost.

An indirect detection method detects that the air pressure of a specific tire among the four tires of a vehicle has fallen in relative terms as compared with the air pressure of the other tires (see Patent Literature 1, for example). With an indirect detection method, tire air pressure is detected as an ABS (Antilock Brake System) extension. ABS measures the rotation speed of each tire, and uses these measured rotation speeds for brake control. The rotation speed of a tire depends on the running speed of the vehicle and the radius of the tire. When the air pressure of a tire falls, the tire collapses, and therefore the rotation radius of the tire decreases. As a result, rotation speed increases only for a tire whose air pressure has fallen, and tire air pressure can be detected by means of this difference in rotation speed. Since an indirect detection method of this kind can utilize an extension of current ABS, it can be installed at lower cost than the above-described direct detection method.

An example of such an indirect detection method is described in Non-Patent Literature 1 shown below. The technology described in Non-Patent Literature 1 utilizes a relationship whereby the spring constant of a tire depends on the air pressure of the tire, and a relationship whereby the spring constant of a tire is proportional to the resonance frequency of the tire. In Non-Patent Literature 1, a method is disclosed whereby, based on these relationships, the resonance frequency of a tire is detected by performing frequency analysis on the measured tire rotation speed, and tire air pressure corresponding to this detected resonance frequency is detected.

### CITATION LIST

### Patent Literature

Japanese Patent Application Laid-Open No. HEI05-133831

### Non-Patent Literature

NPL 1
Takaji Umeno, “Tire Pressure Estimation Using Wheel Speed Sensors”, Toyota Central R&D Labs., Inc. R&D Review, December 1997, Vol. 32 No. 4

### SUMMARY OF INVENTION

### Technical Problem

However, with the method according to Non-Patent Literature 1, tire rotation speed is derived on the assumption that a vibration source for causing mechanical resonance to be generated in a tire is vibration generated in a tire when a vehicle runs on a road surface. When tire rotation speed is derived by means of the method according to Non-Patent Literature 1, this is affected by disturbance such as a coefficient of friction with respect to the road surface, tire wear, or the like. Also, since vibration generated in a tire when a vehicle runs on a road surface is assumed to be a vibration source, when mechanical resonance is not generated in a tire it is not possible to determine with a high degree of precision whether mechanical resonance is mechanical resonance that is affected by vehicular disturbance or mechanical resonance that is not affected by such disturbance. Thus, with a method whereby the resonance frequency of a tire is detected taking the effects of vehicular disturbance into consideration, detection cannot be performed with a high degree of precision since the effects of such disturbance cannot be ignored. As a result, there is a problem of not being able to detect tire air pressure with a high degree of precision.

The present invention has been implemented taking into account the problems described above, and it is an object of the present invention to provide a tire condition detection apparatus and tire condition detection method that enable a tire condition to be detected with a high degree of precision.

### Solution to Problem

A tire condition detection apparatus of the present invention detects a tire condition of a pneumatic tire fixed to a wheel, and has: a vibration input section that inputs predetermined vibration to the tire; a frequency information acquisition section that acquires frequency information of the tire when the predetermined vibration is input; and a tire condition estimation section that extracts a resonance frequency of the tire from the acquired frequency information, and calculates a spring constant when the tire is modeled using an outer moment of inertia, an inner moment of inertia, and the spring constant of elastic force acting therebetween, from the extracted tire resonance frequency.

A tire condition detection method of the present invention detects a tire condition of a pneumatic tire fixed to a wheel, and has: a step of inputting predetermined vibration to the tire; a step of acquiring frequency information of the tire when the predetermined vibration is input; a step of extracting a resonance frequency of the tire from the acquired frequency information; and a step of calculating a spring constant when the tire is modeled using an outer moment of inertia, an inner moment of inertia, and the spring constant of elastic force acting therebetween, from the extracted tire resonance frequency.

### Advantageous Effects of Invention

A tire condition detection apparatus and tire condition detection method according to the present invention enable a tire condition to be detected with a high degree of precision.

### BRIEF DESCRIPTION OF DRAWINGS

FIG. 1 is a block diagram showing an example of the internal configuration of a vehicle that includes a tire condition detection apparatus according to Embodiment 1 of the present invention;

FIG. 2 is a drawing showing time variation of an inverter output current output command value in Embodiment 1;

FIG. 3 is a drawing showing time variation of an actual output value of an inverter output current detected by a current detection section in Embodiment 1;

FIG. 4 is a flowchart showing an example of the operation of a tire condition detection apparatus according to Embodiment 1;

FIG. 5 is a flowchart showing an example of operation by an inverter control section in Embodiment 1;

FIG. 6 is a flowchart showing an example of the operation of a tire condition detection apparatus according to Embodiment 1 while a vehicle is stopped;

FIG. 7 is a drawing showing time variation of an inverter output current output command value while a vehicle is stopped in Embodiment 1;

FIG. 8 is a drawing showing time variation of an actual output value of an inverter output current detected by a current detection section while a vehicle is stopped in Embodiment 1;

FIG. 9 is a drawing showing an example of the overall configuration of a vehicle in which a plurality of tires are arranged with respect to a single motor section in Embodiment 1;

FIG. 10 is a drawing showing time variation of an actual output value of an inverter output current when two tires are arranged with respect to a single motor section in Embodiment 1;

FIG. 11 is a drawing showing time variation of an actual output value of an inverter output current when two tires are arranged with respect to a single motor section, and while a vehicle is stopped, in Embodiment 1;

FIG. 12 is a block diagram showing an example of the internal configuration of a vehicle that includes a tire condition detection apparatus according to Embodiment 2 of the present invention;

FIG. 13 is a drawing showing time variation of rotational angular velocity of a motor section derived by a rotational angular velocity calculation section in Embodiment 2;

FIG. 14 is a flowchart showing an example of the operation of a tire condition detection apparatus according to Embodiment 2;

FIG. 15 is a block diagram showing an example of the configuration of a tire condition detection apparatus according to Embodiment 3 of the present invention;

FIG. 16 is a drawing showing a dynamic model of a tire in Embodiment 3;

FIG. 17 is a flowchart showing an example of the operation of a tire condition detection apparatus according to Embodiment 3;

FIG. 18 is a drawing showing an example of the frequency characteristic of a tire in Embodiment 3;

FIG. 19 is a block diagram showing an example of the configuration of a tire condition detection apparatus according to Embodiment 4 of the present invention;

FIG. 20 is a flowchart showing an example of the operation of a tire condition detection apparatus according to Embodiment 4;

FIG. 21 is a block diagram showing an example of the configuration of a tire condition detection apparatus according to Embodiment 5 of the present invention;

FIG. 22 is a flowchart showing an example of the operation of a tire condition detection apparatus according to Embodiment 5;

FIG. 23 is a block diagram showing an example of the configuration of a tire condition detection apparatus according to Embodiment 6 of the present invention;

FIG. 24 is a flowchart showing an example of the operation of a tire condition detection apparatus according to Embodiment 6;

FIG. 25 is a block diagram showing an example of the configuration of a tire condition detection apparatus according to Embodiment 7 of the present invention;

FIG. 26 is a control block diagram showing an example of the configuration of a motor drive system in Embodiment 7;

FIG. 27 is a block diagram showing an example of the configuration of a tire condition detection apparatus according to Embodiment 8 of the present invention;

FIG. 28 is a block diagram showing an example of the configuration of a tire condition detection apparatus according to Embodiment 9 of the present invention;

FIG. 29 is a block diagram showing an example of the configuration of a tire condition detection apparatus according to Embodiment 10 of the present invention; and

FIG. 30 is a block diagram showing an example of the configuration of a tire condition detection apparatus according to Embodiment 11 of the present invention.

### DESCRIPTION OF EMBODIMENTS

Now, embodiments of the present invention will be described in detail with reference to the accompanying drawings. In the drawings for explaining the embodiments, identical configuration elements and processing operations are assigned the same reference codes, and duplicate descriptions thereof are omitted in the following text.

Before the embodiments are described, the main items of terminology will be explained. “Resonance vibration” is predetermined vibration described later herein for causing resonance to be generated in a tire. “Running torque” is torque (turning force) applied to a tire for running of a vehicle. “Resonance torque” is torque applied to a tire in order to cause resonance vibration to be generated. “Combined torque” is torque combining resonance torque and running torque. “Running current” is a motor drive current (inverter output current) for generating running torque. “Resonance current” is a motor drive current (inverter output current) for generating resonance torque. “Combined drive current” is a motor drive current (inverter output current) for generating combined torque.

### Embodiment 1

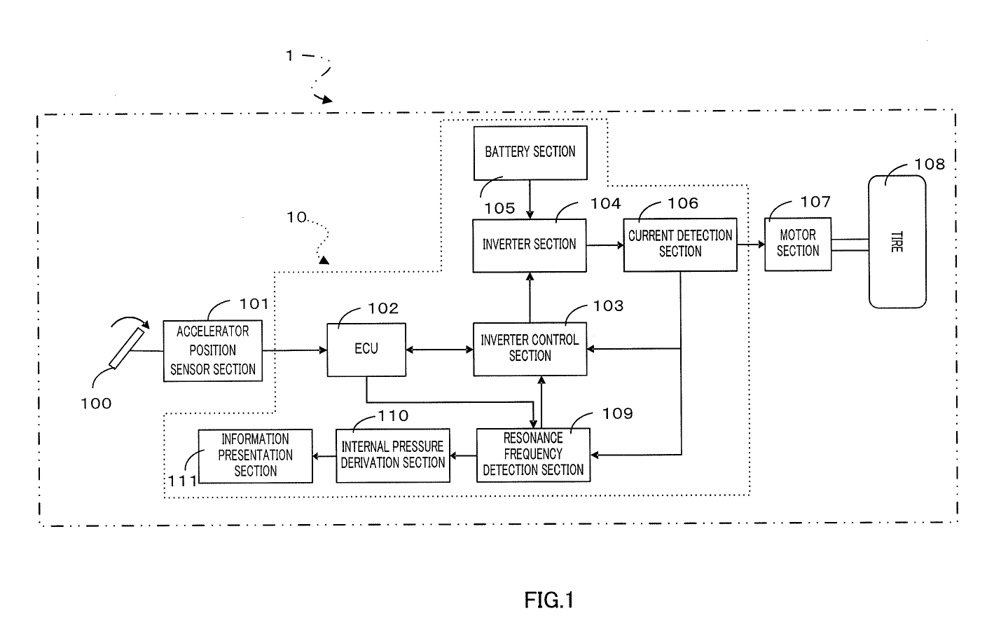

FIG. 1 is a block diagram showing the internal configuration of vehicle 1 that includes tire condition detection apparatus 10 according to Embodiment 1 of the present invention. As shown in FIG. 1, vehicle 1 has accelerator pedal 100, accelerator position sensor section 101, ECU 102, inverter control section 103, inverter section 104, battery section 105, current detection section 106, motor section 107, tire 108, resonance frequency detection section 109, internal pressure derivation section 110, and information presentation section 111. Tire condition detection apparatus 10 mainly comprises ECU 102, inverter control section 103, inverter section 104, battery section 105, current detection section 106, resonance frequency detection section 109, internal pressure derivation section 110, and information presentation section 111. In this embodiment, motor section 107 is a vibration source for causing mechanical resonance to be generated in tire 108.

Accelerator pedal 100 is an in-vehicle part placed in the foot-well of the driver's seat, and is used when the driver causes vehicle 1 to run by accelerating while driving or the like. A degree of depression of accelerator pedal 100 by the driver is detected by accelerator position sensor section 101.

Accelerator position sensor section 101 detects a degree of depression of accelerator pedal 100 by the driver, and sends AP (Accelerator Position) opening information including information relating to this detected degree of depression to ECU 102.

ECU 102 is an electronic control unit comprising a microcomputer, ROM or RAM, and so forth, and performs predetermined signal processing. For example, ECU 102 acquires AP opening information sent from accelerator position sensor section 101, and derives running torque corresponding to this acquired AP opening information. ECU 102 also sends control information for causing a running current to be output by inverter section 104 to inverter control section 103. A running current is a current that it is necessary for inverter section 104 to output to motor section 107 in order for motor section 107 to produce the running torque derived by ECU 102. This control information sent to inverter control section 103 includes a running torque value derived according to AP opening information, command information for causing a running current corresponding to that running torque value to be output by inverter section 104, and so forth.

Also, when inverter control section 103 sends that control information, ECU 102 sends resonance current generation command information for causing a resonance current output command value to be generated to resonance frequency detection section 109. “Resonance current output command value” denotes a command value for causing a resonance current to be output from inverter section 104 via inverter control section 103. “Resonance current generation command information” denotes information for generation of a resonance current output command value by resonance frequency detection section 109. On receiving this resonance current generation command information from ECU 102, resonance frequency detection section 109 generates a resonance current output command value, and sends this generated resonance current output command value to inverter control section 103 at predetermined timing.

The timing at which ECU 102 outputs resonance current generation command information to resonance frequency detection section 109 need not be the same as the timing at which ECU 102 sends control information to inverter control section 103. For example, ECU 102 may constantly send timing information indicating output of resonance current generation command information to inverter control section 103, or ECU 102 may send timing information indicating output of resonance current generation command information to inverter control section 103 in line with timing at which a predetermined switch or the like is pressed by the driver driving vehicle 1.

Inverter control section 103 acquires control information for causing a running current to be output by inverter section 104 from ECU 102. Inverter control section 103 sends running current output command information corresponding to a running torque value included in that control information to inverter section 104. Running current output command information includes the relevant running current output command value, command information for causing that running current output command value to be output from inverter section 104, and so forth. “Running current output command value” denotes a command value for causing the relevant running current to be output by inverter section 104.

Inverter control section 103 also acquires a resonance current generated by resonance frequency detection section 109. This resonance current denotes a resonance current output command value. On acquiring a resonance current output command value from resonance frequency detection section 109, inverter control section 103 sends combined drive current output command information that includes a combined drive current output command value resulting from superposing the above running current output command value and the above resonance current output command value to inverter section 104. A combined drive current is the sum of a running current and a resonance current, and “combined drive current output command value” denotes a value obtained by adding together a running current output command value and a resonance current output command value. Combined drive current output command information includes a combined drive current output command value, command information for causing that combined drive current output command value to be output by inverter section 104, and so forth.

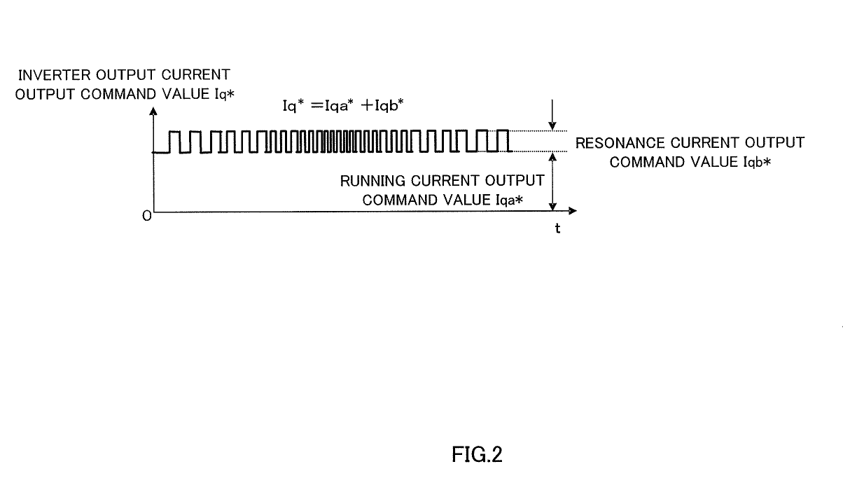

FIG. 2 is a drawing showing time variation of an output command value of an inverter output current output by inverter section 104 under the control of inverter control section 103. Parameter Iqa* represents a running current output command value, parameter Iqb* represents a resonance current output command value, and parameter Iq* represents an inverter output current output command value. As shown in FIG. 2, the horizontal axis represents time, and the vertical axis represents an inverter output current. As shown in FIG. 2, an inverter output current is above-described combined drive current output command value Iq* resulting from superposing running current output command value Iqa* and resonance current output command value Iqb*.

A resonance current output command value is represented by a pulse signal swept in the vicinity of the natural resonance frequency of tire 108, or an alternating-current signal such as a sinusoidal signal. Inverter control section 103 acquires, via current detection section 106, actual output values of a running current or combined drive current actually output by inverter section 104. Inverter control section 103 controls inverter section 104 so that an acquired actual output value and an inverter output current output command value shown in FIG. 2 match.

Inverter section 104 acquires running current output command information sent from inverter control section 103. Inverter section 104 outputs a running current output command value included in this acquired running current output command information after receiving a supply of necessary power from battery section 105. Also, when inverter section 104 acquires above-described combined drive current output command information from inverter control section 103, inverter section 104 outputs a combined drive current included in that output command information after receiving a supply of necessary power from battery section 105.

Battery section 105 supplies inverter section 104 with power necessary for outputting a running current or combined drive current output by inverter section 104.

Current detection section 106 detects actual output values of a running current or combined drive current actually output from inverter section 104. Current detection section 106 constantly detects running current or combined drive current actual output values. These detected running current or combined drive current actual output values are detected by inverter control section 103 and resonance frequency detection section 109.

Motor section 107 has actual running current or combined drive current output values as input, and drives tire 108 by outputting a running torque value derived by ECU 102 based on these input running current or combined drive current actual output values. Tire 108 is a tire of so-called vehicle 1, and is connected to vehicle 1 in a stable and fixed manner. Tire 108 includes a gas between itself and a wheel. This gas may be air, nitrogen, or the like. Although a single tire is shown in FIG. 1, a plurality of tires may be connected as described later herein.

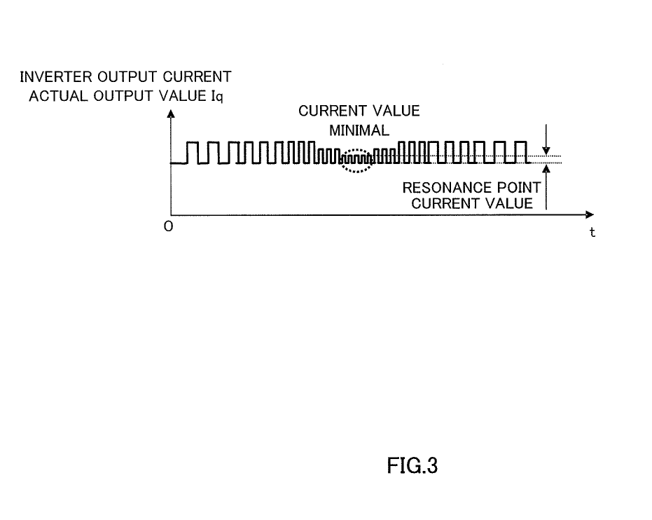

FIG. 3 is a drawing showing time variation of an actual output value of an inverter output current detected by inverter section 104 for the inverter output current output command values shown in FIG. 2.

As shown in FIG. 3, resonance frequency detection section 109 detects actual output values of an inverter output current that is a running current or combined drive current via current detection section 106. Resonance frequency detection section 109 derives a frequency when that acquired inverter output current is minimal as a tire 108 resonance frequency. Why this frequency when the inverter output current is minimal is the tire 108 resonance frequency is explained below.

Assume that an inverter output current actually output from inverter section 104 is input to motor section 107, and mechanical resonance is generated in tire 108. At this time, a counter electromotive force is induced by electromagnetic induction inside motor section 107 connected to that tire 108 in a stable and fixed manner due to that resonance. Based on this induced counter electromotive force, a countercurrent due to that counter electromotive force flows in the opposite direction to the current input to motor section 107, and therefore the impedance of motor section 107 as seen from inverter section 104 becomes maximal. When the impedance of motor section 107 is maximal, a state arises in which it is most difficult for the current input to motor section 107 to flow, and therefore the inverter output current has a minimal value as shown in FIG. 3. Therefore, when the inverter output current is minimal, mechanical resonance occurs in tire 108, and the resonance frequency of tire 108 connected to motor section 107 in a stable and fixed manner is detected.

In deriving the resonance frequency of tire 108, resonance frequency detection section 109 performs, for example, frequency analysis (FFT or the like) of an inverter output current detected by current detection section 106. In a spectral waveform resulting from this frequency analysis, a sharp peak appears at the resonance frequency of tire 108, and therefore the frequency at which this peak appears is determined to be the resonance frequency of tire 108. Resonance frequency detection section 109 sends information relating to the detected resonance frequency to internal pressure derivation section 110.

Internal pressure derivation section 110 derives the internal pressure of tire 108 based on the resonance frequency sent from resonance frequency detection section 109. The internal pressure of tire 108 is derived, for example, based on the fact that the resonance frequency of tire 108 and a tire spring constant are proportional to each other, and a tire spring constant and the internal pressure of tire 108 are proportional to each other (see Non-Patent Literature 1, for example). However, the internal pressure derivation method is not limited to the method described in Non-Patent Literature 1.

Information presentation section 111 presents the driver of vehicle 1 with internal pressure information relating to the internal pressure of tire 108 derived by internal pressure derivation section 110. In this presentation, information may be indicated by a meter or the like, or may be displayed on the display of a car navigation apparatus or the like previously installed in vehicle 1.

(Operation of Tire Condition Detection Apparatus 10)

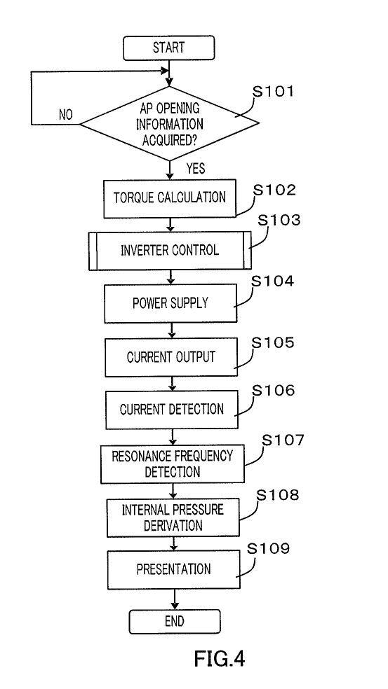

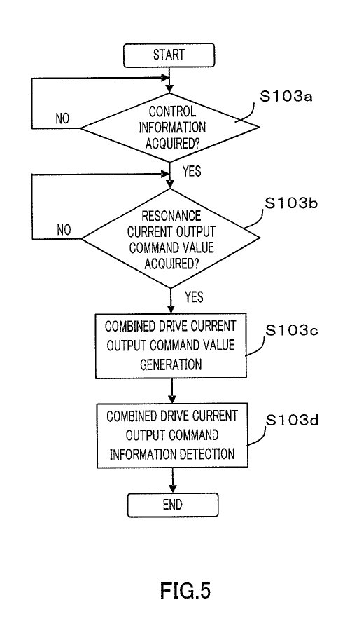

The operation of tire condition detection apparatus 10 according to this embodiment will now be described with reference to FIG. 4 and FIG. 5.

FIG. 4 is a flowchart showing the operation of tire condition detection apparatus 10 according to this embodiment, and FIG. 5 is a flowchart showing details of the operation of inverter control section 103 of tire condition detection apparatus 10 according to this embodiment.

When the driver driving vehicle 1 depresses accelerator pedal 100 to a predetermined degree, accelerator position sensor section 101 detects the degree of depression of depressed accelerator pedal 100. ECU 102 acquires AP opening information including information relating to this detected degree of depression from accelerator position sensor section 101 (S101).

ECU 102 acquires the AP opening information sent from accelerator position sensor section 101 (S101: YES). Based on this acquired AP opening information, ECU 102 calculates output torque (running torque) necessary for motor section 107 to rotate tire 108 (S102). ECU 102 sends control information for causing a running current to be output by inverter section 104 to inverter control section 103 (S103). As explained above, when this control information is sent to inverter control section 103, ECU 102 sends resonance current generation command information that causes a resonance current output command value to be generated to resonance frequency detection section 109.

As shown in FIG. 5, when inverter control section 103 acquires control information from ECU 102 (S103a: YES), inverter control section 103 determines whether or not a resonance current output command value has been acquired from resonance frequency detection section 109 (S103b). If inverter control section 103 has acquired a resonance current output command value (S103b: YES), inverter control section 103 generates a combined drive current output command value resulting from superposing a running current output command value and a resonance current output command value (S103c). Inverter control section 103 sends combined drive current output command information that performs control so as to output this generated combined drive current output command value, to inverter section 104 (S103d).

Inverter section 104 acquires the combined drive current output command information from inverter control section 103. Based on this acquired combined drive current output command information, inverter section 104 receives a supply of necessary power from battery section 105 (S104), and outputs a combined drive current corresponding to that output command information (S105).

Current detection section 106 detects an actual output value of a combined drive current actually output from inverter section 104 (S106). Time variation of this detected combined drive current (inverter output value) actual output value is as shown in FIG. 3.

Resonance frequency detection section 109 derives a frequency when a combined drive current (inverter output value) actual output value detected by current detection section 106 is minimal as the resonance frequency of tire 108. Resonance frequency detection section 109 detects the resonance frequency of tire 108 by performing, for example, frequency analysis (FFT or the like) of a combined drive current detected by current detection section 106 (S107).

Internal pressure derivation section 110 derives the internal pressure of tire 108 based on a resonance frequency sent from resonance frequency detection section 109 (S108). Information presentation section 111 presents the driver of vehicle 1 with internal pressure information relating to the internal pressure of tire 108 derived by internal pressure derivation section 110, and tire condition detection apparatus operation ends.

As described above, in tire condition detection apparatus 10 according to this embodiment, resonance frequency detection section 109 sends a resonance current swept in the vicinity of the natural resonance frequency of tire 108 to inverter control section 103. Inverter control section 103 sends an output command value of a combined drive current resulting from superposition of this resonance current and a running current to inverter section 104. The resonance frequency of tire 108 is detected from an actual output value of a combined drive current actually output by inverter section 104.

Therefore, mechanical resonance of tire 108 is determined from time variation of an actual output value of a combined drive current input to motor section 107 that is connected to tire 108 in a stable and fixed manner, making it unnecessary to take the effects of vehicle 1 disturbance into consideration, and enabling the resonance frequency of tire 108 to be determined with a high degree of precision. Since the resonance frequency of tire 108 can be determined with a high degree of precision, the internal pressure of the tire can in turn be detected with a high degree of precision.

(Operation of Tire Condition Detection Apparatus 10 while Vehicle is Stopped)

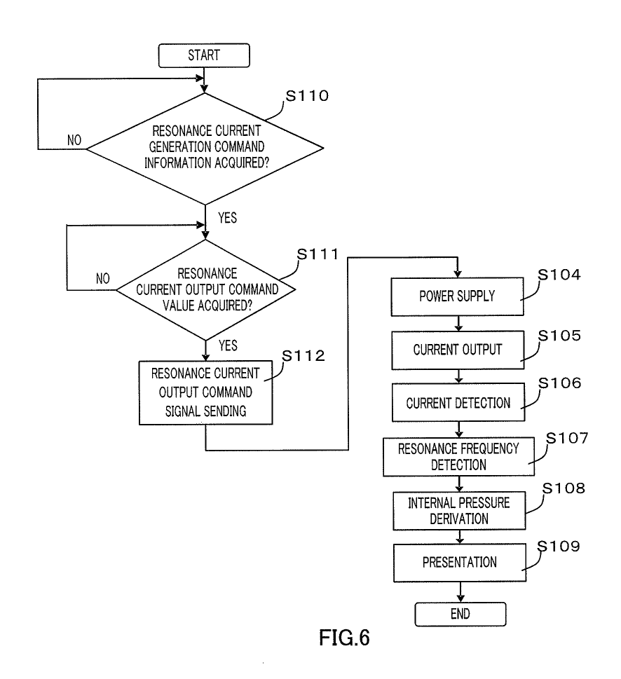

The operations whereby tire condition detection apparatus 10 according to this embodiment derives the internal pressure of tire 108 while vehicle 1 is stopped will now be described with reference to FIG. 6 through FIG. 8.

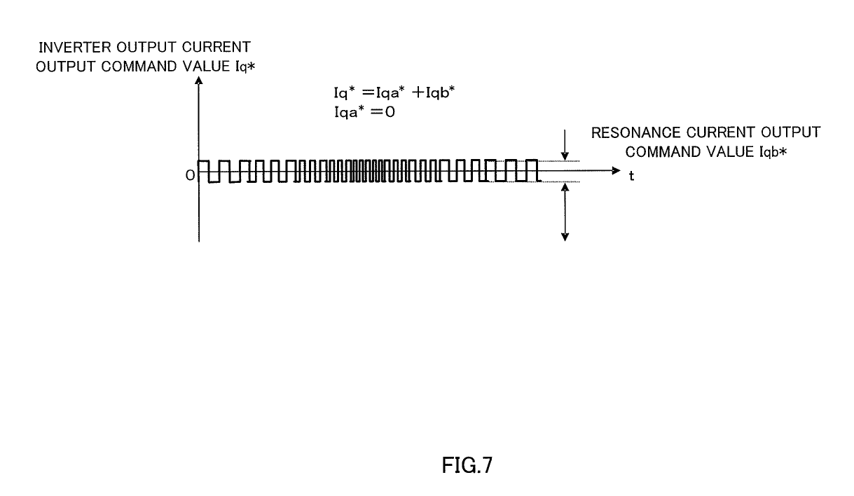

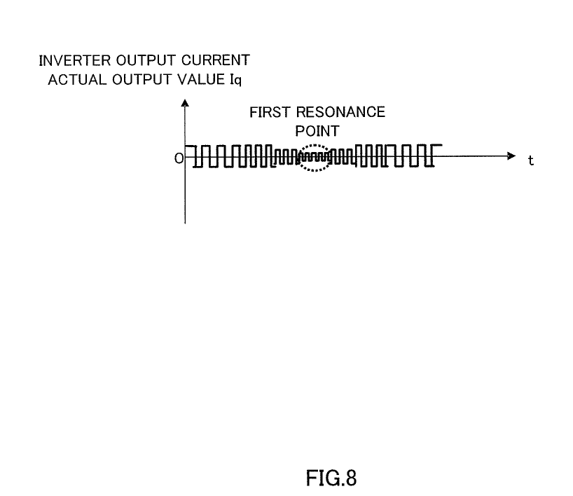

FIG. 6 is a flowchart showing an example of the operation of tire condition detection apparatus 10 according to Embodiment 1 while the vehicle is stopped, FIG. 7 is a drawing showing time variation of an inverter output current output command value sent to inverter section 104 by inverter control section 103 while the vehicle is stopped, and FIG. 8 is a drawing showing time variation of an actual output value of an inverter output current detected by current detection section 106 while the vehicle is stopped.

When vehicle 1 is stopped, accelerator pedal 100 is not depressed by the driver. That is to say, accelerator position sensor section 101 does not detect a degree of depression from accelerator pedal 100. ECU 102, for example, acquires an input signal corresponding to depression of a predetermined switch or the like by the driver, and sends resonance current generation command information to resonance frequency detection section 109 based on this input signal (S110). The timing at which this resonance current generation command information is sent to resonance frequency detection section 109 need not be the timing of depression of a predetermined switch or the like by the driver. For example, this timing may be timing at which vehicle 1 is determined to have stopped running by means of a wheel speed sensor or the like (not shown), or may be timing when a predetermined time has elapsed since immediately after vehicle 1 stopped running according to measurement by a timer or the like (not shown). Provision may also be made for ECU 102 to send resonance current generation command information to resonance frequency detection section 109 constantly when vehicle 1 is not running.

When resonance frequency detection section 109 acquires resonance current generation command information from ECU 102 (S110: YES), resonance frequency detection section 109 generates a resonance current output command value, and sends this generated resonance current output command value to inverter control section 103 at predetermined timing (S111).

Inverter control section 103 acquires the resonance current output command value (S111: YES), and sends resonance current output command information that performs control so as to output this acquired resonance current output command value, to inverter section 104 (S112). A resonance current output command value included in this sent resonance current output command information corresponds to resonance current output command value Iqb* shown in FIG. 2 (see FIG. 7). The processing subsequent to S112 is identical to processing to which corresponding reference codes are assigned shown in FIG. 4, and therefore a description thereof is omitted here.

As described above, the absolute value of an output command value of a current that inverter control section 103 causes to be output by inverter section 104 differs in a state in which vehicle 1 continues not to be running and in a state in which vehicle 1 is running. Specifically, the absolute value of an inverter output current corresponding to a state in which vehicle 1 is running is inverter output current output command value Iq* (=(running current output command value Iqa*)+(resonance current output command value Iqb*)), as shown in FIG. 2. On the other hand, the absolute value of an inverter output current corresponding to a state in which vehicle 1 continues not to be running is only resonance current output command value Iqb*, as shown in FIG. 7.

Therefore, even in a state in which vehicle 1 continues to be stopped, tire condition detection apparatus 10 according to this embodiment can determine a tire resonance frequency with a high degree of precision simply by making a command value of an inverter output current that is caused to be output by inverter section 104 a resonance current output command value. As a result, tire condition detection apparatus 10 according to this embodiment can detect the internal pressure of a tire with a high degree of precision irrespective of the running state of vehicle 1, whether running or stopped.

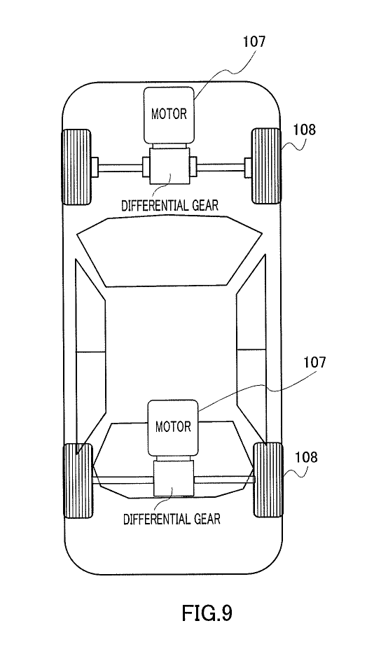

FIG. 9 is an outline drawing showing the overall configuration of a vehicle in which a plurality of tires 108 are arranged in a fixed manner with respect to motor section 107 via a differential gear.

Tire condition detection apparatus 10 according to this embodiment can also detect the internal pressure of tire 108 with a high degree of precision in a similar way in a case in which vehicle 1 is a vehicle such as shown in FIG. 9. That is to say, a single tire 108 may be attached to motor section 107, or a plurality of tires 108 may be attached.

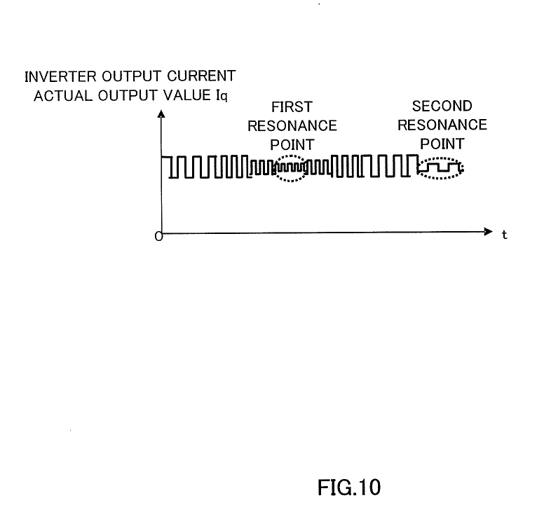

FIG. 10 is a drawing showing how two tire resonance frequencies appear when two tires are arranged with respect to motor section 107. In this case, tire condition detection apparatus 10 performs the operations shown in FIG. 4 and FIG. 5 individually for each tire 108. As shown in FIG. 10, a first minimal value corresponding to the resonance frequency (resonance point) of a first tire 108, and a second minimal value corresponding to the resonance frequency (resonance point) of a second tire 108, are detected in actual output values of an inverter output current output by inverter section 104.

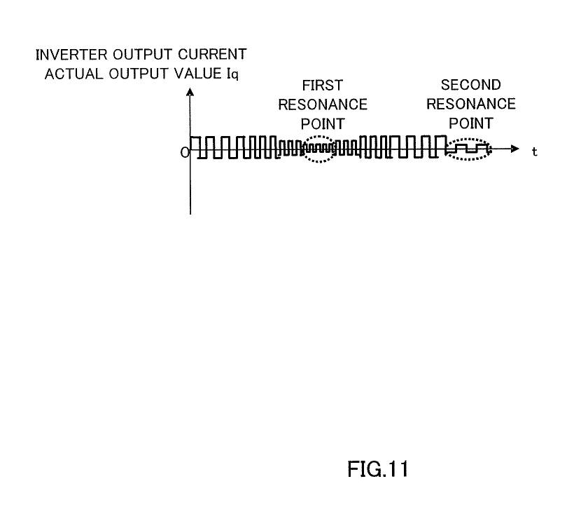

FIG. 11 is a drawing showing how first and second minimal values corresponding respectively to two tire resonance frequencies (resonance points) appear in a case in which a vehicle is stopped when two tires are arranged with respect to motor section 107.

Tire condition detection apparatus 10 according to this embodiment can also detect the internal pressure of tire 108 with a high degree of precision in a similar way in a case in which tire condition detection apparatus 10 is installed in a vehicle such as shown in FIG. 9, and that vehicle is stopped.

### Embodiment 2

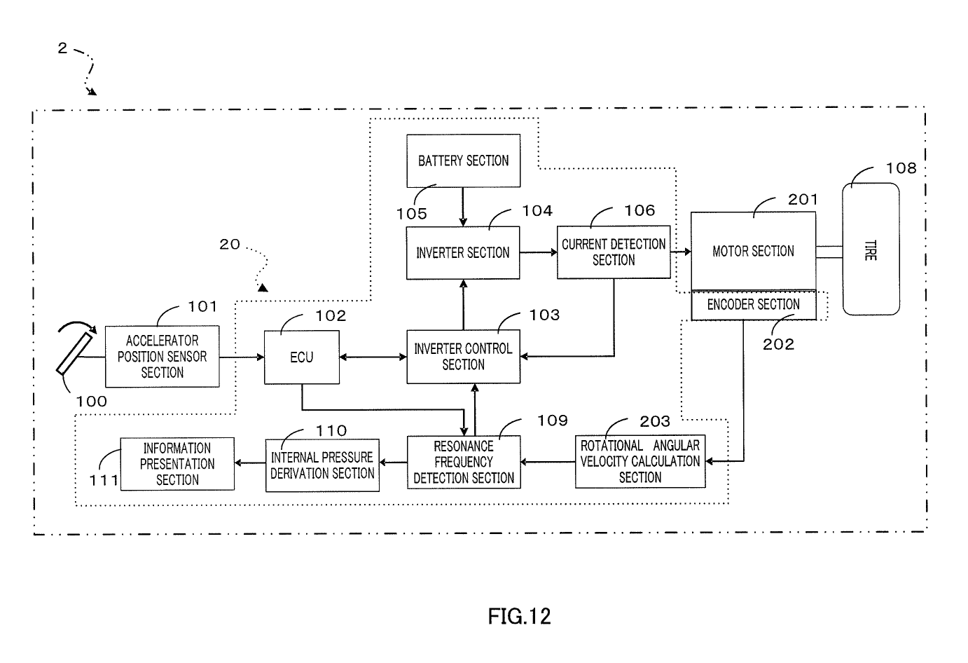

FIG. 12 is a block diagram showing the internal configuration of vehicle 2 that includes tire condition detection apparatus 20 according to Embodiment 2 of the present invention. Tire condition detection apparatus 20 according to this embodiment differs from tire condition detection apparatus 10 according to this embodiment in having motor section 201, encoder section 202, and rotational angular velocity calculation section 203, as shown in FIG. 12. Apart from these differences, tire condition detection apparatus 20 is similar to tire condition detection apparatus 10 of Embodiment 1, and configuration elements in FIG. 12 common to FIG. 1 are assigned the same reference codes as in FIG. 1.

As compared with motor section 107, motor section 201 is further provided with encoder section 202. Encoder section 202 detects the rotation angle of a rotor relative to a stator of motor section 201, and sends this detected rotation angle to rotational angular velocity calculation section 203. Encoder section 202 may be an optical encoder such as an incremental encoder or absolute encoder, or may be an electromagnetic encoder comprising a Hall element or the like.

Rotational angular velocity calculation section 203 acquires a rotation angle sent from encoder section 202, and derives rotational angular velocity ω by performing temporal differentiation of this acquired rotation angle. Parameter ω represents rotational angular velocity. Rotational angular velocity calculation section 203 sends this derived rotational angular velocity ω to resonance frequency detection section 109.

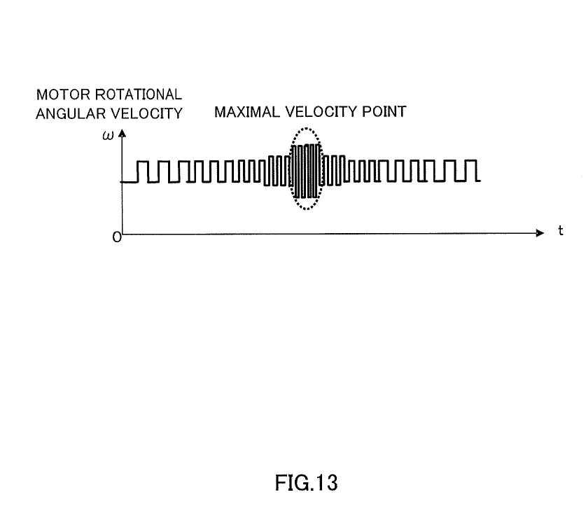

When inverter control section 103 outputs an inverter output current output command value to inverter section 104, rotational angular velocity derived by rotational angular velocity calculation section 203 is indicated as shown in FIG. 13. FIG. 13 is a drawing showing time variation of rotational angular velocity of motor section 201 derived by rotational angular velocity calculation section 203.

A combined drive current actually output from inverter section 104 is input to motor section 201, and mechanical resonance is generated in tire 108. At this time, the rotation speed of motor section 201 connected to tire 108 in a stable and fixed manner becomes highest at the resonance frequency of tire 108. Consequently, rotational angular velocity ω derived by performing temporal differentiation of a rotation speed output from encoder section 202 gradually increases as the resonance frequency of tire 108 is approached, and becomes maximal at the resonance frequency. Therefore, as shown in FIG. 13, when the rotation speed of motor section 201 becomes maximal, mechanical resonance is generated in tire 108, and the resonance frequency of tire 108 connected to motor section 201 in a stable and fixed manner is detected.

(Operation of Tire Condition Detection Apparatus 20)

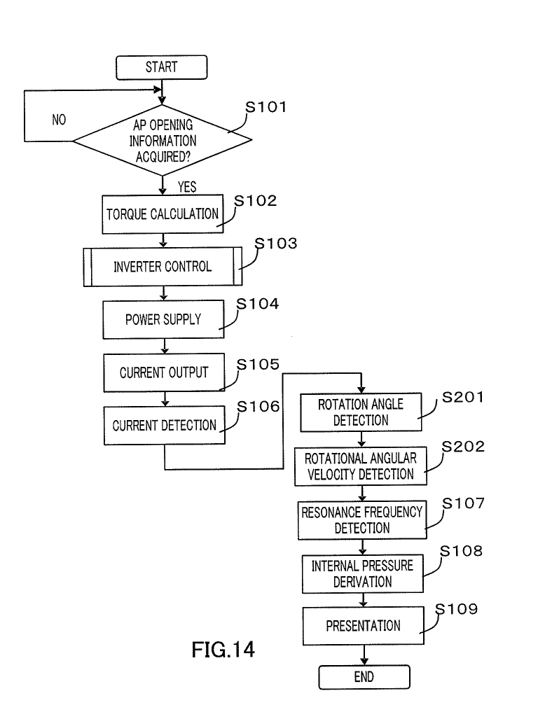

The operation of tire condition detection apparatus 20 according to this embodiment will now be described with reference to FIG. 14. FIG. 14 is a flowchart showing the operation of tire condition detection apparatus 20 according to this embodiment. The inverter control operation shown in FIG. 14 comprises the same operations as shown in FIG. 5, and therefore a description of inverter control operation is omitted here.

When the driver driving vehicle 2 depresses accelerator pedal 100 to a predetermined degree, accelerator position sensor section 101 detects the degree of depression of depressed accelerator pedal 100. ECU 102 acquires AP opening information including information relating to this detected degree of depression from accelerator position sensor section 101 (S101).

ECU 102 acquires the AP opening information sent from accelerator position sensor section 101 (S101: YES). Based on this acquired AP opening information, ECU 102 calculates output torque (running torque) necessary for motor section 107 to rotate tire 108 (S102). ECU 102 sends control information for causing a running current to be output by inverter section 104 to inverter control section 103 (S103). When this control information is sent to inverter control section 103, ECU 102 sends resonance current generation command information that causes a resonance current output command value to be generated to resonance frequency detection section 109.

Inverter section 104 acquires combined drive current (inverter output current) output command information from inverter control section 103. Based on this acquired combined drive current output command information, inverter section 104 receives a supply of necessary power from battery section 105 (S104), and outputs a combined drive current corresponding to that output command information (S105).

Current detection section 106 detects an actual output value of a combined drive current actually output from inverter section 104 (S106). An actual output value of this detected combined drive current is detected by inverter control section 103. encoder section 202

Encoder section 202 detects the rotation angle of motor section 201 (S201), and sends this detected rotation angle to rotational angular velocity calculation section 203. Rotational angular velocity calculation section 203 acquires the motor section 201 rotation angle sent from encoder section 202, and derives rotational angular velocity ω by performing temporal differentiation of this acquired rotation angle (S202). Rotational angular velocity calculation section 203 sends this derived rotational angular velocity ω to resonance frequency detection section 109.

Resonance frequency detection section 109 acquires rotational angular velocity ω of motor section 201 derived by rotational angular velocity calculation section 203, and derives a frequency when the value of this acquired rotational angular velocity is maximal as the resonance frequency of tire 108. Resonance frequency detection section 109 detects the resonance frequency of tire 108 by performing, for example, frequency analysis (FFT or the like) of rotational angular velocity derived by rotational angular velocity calculation section 203 (S107).

Internal pressure derivation section 110 derives the internal pressure of tire 108 based on a resonance frequency sent from resonance frequency detection section 109 (S108). Information presentation section 111 presents the driver of vehicle 2 with internal pressure information relating to the internal pressure of tire 108 derived by internal pressure derivation section 110, and tire condition detection apparatus operation ends.

As described above, in tire condition detection apparatus 20 according to this embodiment, resonance frequency detection section 109 sends a resonance current swept in the vicinity of the natural resonance frequency of tire 108 to inverter control section 103. Inverter control section 103 sends an output command value of a combined drive current resulting from superposition of this resonance current and a running current to inverter section 104. Encoder section 202 detects the rotation angle of motor section 201 driven by an actual output value of a combined drive current actually output by inverter section 104, and the rotational angular velocity of motor section 201 is derived from temporal differentiation of this detected rotation angle. The resonance frequency of tire 108 is detected from this derived rotational angular velocity of motor section 201.

Therefore, mechanical resonance of tire 108 can also be determined from time variation of the rotational angular velocity of motor section 201 that is connected to tire 108 in a stable and fixed manner. Consequently, it is not necessary to take the effects of vehicle 2 disturbance into consideration, and the resonance frequency of tire 108 can be determined with a high degree of precision. Since the resonance frequency of tire 108 can be determined with a high degree of precision, the internal pressure of the tire can in turn be detected with a high degree of precision.

Embodiments have been described above with reference to the accompanying drawings, but it goes without saying that an input apparatus of the present invention is not limited to such examples, and various variations and modifications may be possible by those skilled in the art based on the content of the claims without departing from the technological scope of the present invention.

In the above embodiments, tire condition detection apparatus 10 or 20 has been described as having internal pressure derivation section 110 and information presentation section 111 as essential configuration elements. However, internal pressure derivation section 110 and information presentation section 111 may have any configuration with respect to tire condition detection apparatus 10 or 20.

In the above embodiments, resonance current output command information has been described as being generated by resonance frequency detection section 109. However, it does not matter if resonance frequency detection section 109 does not generate a resonance current. For example, resonance frequency detection section 109 may send timing information for causing resonance current output command information to be generated by inverter control section 103 itself, and information relating to the natural resonance frequency of tire 108. Upon acquiring that timing information, inverter control section 103 generates an output command value of a resonance current swept in the vicinity of the natural resonance frequency of tire 108, and sends combined drive current output command information that includes a combined drive current output command value superposed on an above-described running current output command value to inverter section 104. Also, it does not matter if inverter control section 103 does not acquire information relating to the natural resonance frequency of tire 108 from resonance frequency detection section 109. For example, provision may be made for inverter control section 103 to acquire information relating to the natural resonance frequency of tire 108 from ECU 102.

In the same way as tire condition detection apparatus 10 according to Embodiment 1, tire condition detection apparatus 20 according to Embodiment 2 can derive the internal pressure of tire 108 even when vehicle 2 that includes that tire condition detection apparatus 20 is not running. Also, in the same way as tire condition detection apparatus 10 according to Embodiment 1, tire condition detection apparatus 20 can derive the internal pressure of each tire 108 in a case in which a plurality of tires are connected to motor section 201 in a stable and fixed manner.

### Embodiment 3

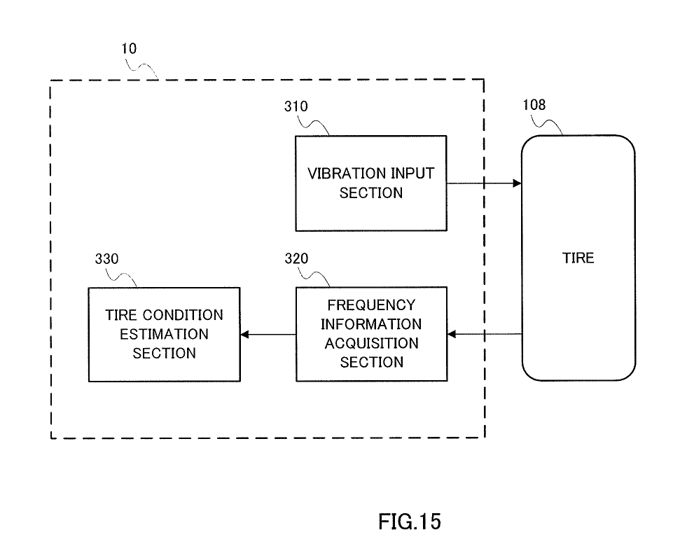

FIG. 15 is a block diagram showing an example of the configuration of a tire condition detection apparatus according to Embodiment 3.

As shown in FIG. 15, tire condition detection apparatus 10 is an apparatus connected to tire fixed to a wheel (hereinafter referred to simply as “tire”) 108, and has vibration input section 310, frequency information acquisition section 320, and tire condition estimation section 330. Tire 108 is connected to this vehicle in a stable and fixed manner, and includes a gas such as air, nitrogen, or the like, between itself and a wheel.

Frequency information acquisition section 320 corresponds to encoder section 202, current detection section 106, resonance frequency detection section 109, and rotational angular velocity calculation section 203 in Embodiment 1 and/or Embodiment 2. Tire condition estimation section 330 corresponds to internal pressure derivation section 110 in Embodiment 1 and Embodiment 2.

Vibration input section 310 inputs predetermined vibration to tire 108. In order for the resonance frequency of tire 108 to be easily extracted by frequency information acquisition section 320 described later herein, the predetermined vibration is minute back-and-forth vibration applied in the direction of rotation of tire 108, and is defined by torque magnitude and vibrational frequency. This predetermined vibration is called “resonance vibration” in line with the above definition.

Vibration input section 310 may apply vibration by controlling the drive system of tire 108 electrically or mechanically, or may apply vibration mechanically directly to tire 108 separately from the drive system. If vibration is directly applied mechanically, vibration input section 310 can be, for example, an electromagnetic vibrator, or an unbalanced-mass vibrator in which an eccentric mass is attached to a small motor, that is attached to the wheel of tire 108 or the like. Vibration input section 310 can also be, for example, a damper oil-pressure control apparatus, such as active suspension.

Frequency information acquisition section 320 acquires tire 108 frequency information when resonance vibration is input by vibration input section 310. Frequency information is information for extracting the tire 108 resonance frequency described later herein. Frequency information includes the rotational angular velocity of tire 108, for example. Also, when the rim of tire 108 is driven by a motor, frequency information is an inverter control voltage for induced electromotive force reduction in a motor-drive vehicle. In the case of rotational angular velocity, for example, an encoder (not shown) that detects the rotation angle of a rotor relative to a stator of tire 108 can be installed and can acquire a rotation angle of the rim, and rotational angular velocity can be acquired by performing temporal differentiation on rim rotation angles. The encoder may be, for example, an optical encoder such as an incremental encoder or absolute encoder, or an electromagnetic encoder comprising a Hall element or the like.

Tire condition estimation section 330 extracts the resonance frequency of tire 108 from frequency information acquired by frequency information acquisition section 320, and estimates the condition of tire 108. Then tire condition detection apparatus 10 estimates the condition of tire 108 using a dynamic model of tire 108. Specifically, tire condition estimation section 330 calculates a torsional spring constant of a dynamic model of tire 108 each time detection of the condition of tire 108 is performed, and estimates the condition of tire 108 based on the calculated torsional spring constant.

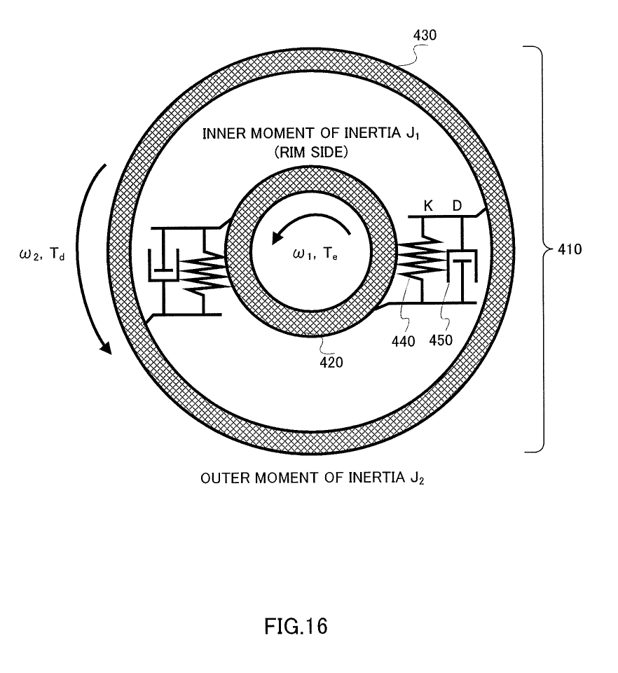

FIG. 16 is a drawing showing a dynamic model of tire 108 used by tire condition estimation section 330.

As shown in FIG. 16, tire 108 dynamic model 410 includes a moment of inertia of tire 108 rim 420, a moment of inertia of tire 108 tread 430, spring (torsional spring) 440 connecting these, and damper 450. That is to say, tire 108 dynamic model 410 models mechanical vibration generated in tire 108 as a torsional vibration phenomenon. Dynamic model 410 is represented using the following variables.

J₁: Moment of inertia of rim 420 (inner moment of inertia)

J₂: Moment of inertia of tread 430 (outer moment of inertia)

K: Torsional spring constant of tire 108

D: Equivalent viscosity coefficient of tire 108

Tₑ: Output torque applied to rim 420 from vehicle side

T_{d}: Disturbance torque applied to tread 430 from road surface due to rolling of tire 108

ω₁: Rotational angular velocity of rim 420

ω₂: Rotational angular velocity of tread 430

Here, θₛ denotes the rotation angle difference between rim 420 and tread 430. Moment of inertia J₁, outer moment of inertia J₂, and equivalent viscosity coefficient D, are parameters that can be regarded as fixed values. Torsional spring constant K is a parameter representing the elasticity of the inner-surface rubber part of tire 108 that connects rim 420 and tread 430, and is dependent upon air pressure (hereinafter referred to as “tire internal pressure”). Output torque Tₑ is a control object. Disturbance torque T_{d} is an unknown parameter. Rotational angular velocity ω₁ is a parameter that can be measured with a high degree of precision.

Although not shown in the drawings, tire condition detection apparatus 10 has, for example, a CPU (Central Processing Unit), a storage medium such as RAM (Random Access Memory), and so forth. In this case some or all of the above-described functional sections are implemented by having the CPU execute a control program. Tire condition detection apparatus 10 can, for example, take the form of an ECU that is installed in a vehicle and is connected to the drive system of tire 108.

Since such a tire condition detection apparatus 10 extracts the resonance frequency of tire 108, it can detect the condition of tire 108 by acquiring the torsional spring constant of tire 108 with a high degree of precision.

The operation of tire condition detection apparatus 10 will now be described.

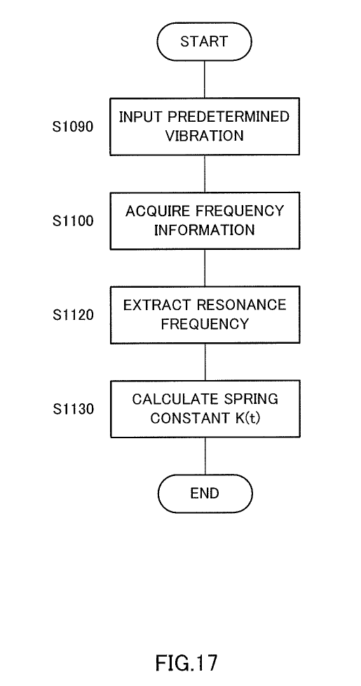

FIG. 17 is a flowchart showing an example of the operation of tire condition detection apparatus 10 according to Embodiment 3.

First, each time timing for estimating the tire condition (hereinafter referred to as “estimation execution timing”) arrives, vibration input section 310 inputs predetermined vibration to tire 108 (S1090). Estimation execution timing may be while a vehicle that is a detection object is running or is stopped, and may be while the vehicle is running at a constant speed or running at an inconstant speed. Also, estimation execution timing may arrive with predetermined periodicity, or may be when a predetermined operation such as depression of a switch is performed by the driver.

Then frequency information acquisition section 320 acquires tire 108 frequency information, and outputs the acquired frequency information to tire condition estimation section 330 (S1100). Tire condition estimation section 330 extracts the resonance frequency of tire 108 from the input frequency information (S1120). Then tire condition estimation section 330 calculates torsional spring constant K of tire 108 from the extracted resonance frequency (S1130).

Here, a method is described whereby tire condition estimation section 330 extracts a resonance frequency, and calculates torsional spring constant K based on the resonance frequency. Here, a case is described in which rim 420 rotational angular velocity ω₁ is input to tire condition estimation section 330 as frequency information.

Frequency information is, for example, a frequency of a control voltage for controlling a current that suppresses an induced electromotive force generated by motor rotation with respect to a motor drive voltage.

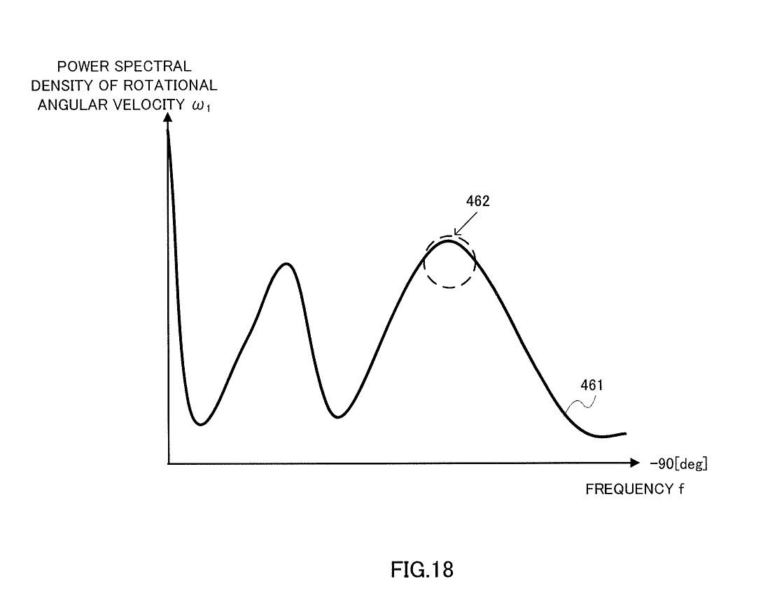

FIG. 18 is a drawing showing an example of the frequency characteristic of tire 108. The horizontal axis indicates frequency f, and the vertical axis indicates the power spectral density of rim 420 rotational angular velocity ω₁.

Tire condition estimation section 330 can obtain spectral waveform 461 shown in FIG. 18 by performing frequency analysis such as an FFT (Fast Fourier Transform) on rim 420 rotational angular velocity ω₁.

As shown in FIG. 18, in spectral waveform 461 indicating a frequency characteristic of tire 108, a resonance frequency that is affected by tire internal pressure appears at frequency 462 as coupled resonance of suspension back-and-forth vibration and tire 108 torsional spring resonance. Details of this phenomenon are given in Non-Patent Literature 1, for example, and therefore a description thereof is omitted here.

In spectral waveform 461, a sharp peak appears at above-mentioned frequency 462, which is the resonance frequency of tire 108.

Thus, tire condition estimation section 330 acquires resonance frequency 462 by detecting a peak position in spectral waveform 461.

Incidentally, tire 108 resonance frequency f_{c0} is generally expressed by equation 1 below from a two-inertia system model.

$$\begin{matrix}( Equation 1 ) & \\ {f}_{c 0} = \frac{1}{2 π} \sqrt{K ( \frac{1}{{J}_{1}} + \frac{1}{{J}_{2}} )} & [ 1 ]\end{matrix}$$

Therefore, tire condition estimation section 330 detects resonance frequency f_{c0}, and can calculate torsional spring constant K from moment of inertia J₁ and outer moment of inertia J₂, which are fixed values, using equation 1.

Here, frequency information includes a large amount of vibration noise due to vibration components other than a tire resonance frequency, caused by a coefficient of friction between a tire and the road surface, and irregularities. Resonance frequency f_{c0} is difficult to detect with conventional technology since it tends to be buried in this noise.

Thus, as explained above, in tire condition detection apparatus 10 provision is made for predetermined vibration that facilitates the extraction of resonance frequency f_{c0} to be input by vibration input section 310. By this means, tire condition detection apparatus 10 can extract resonance frequency f_{c0} more dependably and with a high degree of precision.

Tire condition estimation section 330 may also calculate resonance frequency f_{c0}, and calculate torsional spring constant K, by means of the method described below, for example.

Tire condition estimation section 330 may also calculate torsional spring constant K using a batch least-squares estimation method such as described in Non-Patent Literature 1.

Then tire condition estimation section 330 calculates torsional spring constant K of tire 108 from calculated resonance frequency f_{c0}, using equation 1.

Thus, if tire condition detection apparatus 10 can extract resonance frequency f_{c0}, it can calculate torsional spring constant K representing the current condition of tire 108 with a high degree of precision.

As described above, tire condition detection apparatus 10 according to Embodiment 3 applies predetermined vibration to tire 108, acquires tire 108 frequency information, and extracts the resonance frequency of tire 108 from that frequency information. Then tire condition detection apparatus 10 estimates the condition of tire 108 from the extracted resonance frequency. By this means, tire condition detection apparatus 10 can calculate a torsional spring constant of a tire 108 dynamic model on a case-by-case basis, and can detect the condition of tire 108 with a high degree of precision.

With the technology described in above Non-Patent Literature 1, input of vibration for facilitating the extraction of the resonance frequency of tire 108 described later herein is not performed. Therefore, with the technology described in Non-Patent Literature 1, a resonance frequency cannot be extracted dependably and with a high degree of precision.

Therefore, as compared with this kind of technology described in Non-Patent Literature 1, tire condition detection apparatus 10 according to this embodiment can perform detection of the condition of tire 108 with a higher degree of precision.

### Embodiment 4

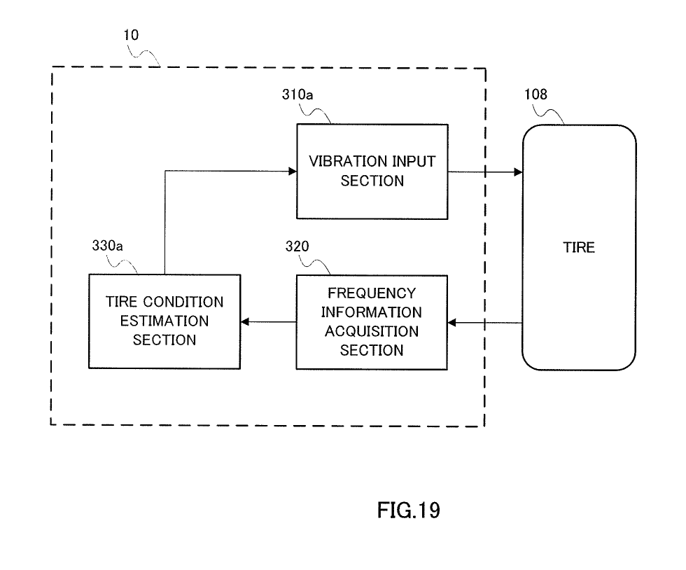

FIG. 19 is a block diagram showing an example of the configuration of a tire condition detection apparatus according to Embodiment 4 of the present invention, corresponding to FIG. 15 of Embodiment 3.

Tire condition detection apparatus 10 according to Embodiment 4 mainly differs from Embodiment 3 in being provided with vibration input section 310a that decides resonance vibration based on tire condition related information acquired in the past, and tire condition estimation section 330a that feeds back tire condition related information.

Tire condition estimation section 330a determines whether or not tire 108 air pressure has dropped markedly based on a change in torsional spring constant K. Then tire condition estimation section 330a holds resonance frequency f_{c0} and a determination result as to whether or not there is a marked drop in tire air pressure (hereinafter referred to as “air pressure drop”) due to a puncture or the like.

Vibration input section 310a acquires resonance frequency f_{c0} and information on the presence or absence of an air pressure drop held by tire condition estimation section 330a. Then, based on these items of information, vibration input section 310a controls at least one or the other of torque magnitude and vibrational frequency, or both of these, so that resonance frequency f_{c0} becomes easily extracted vibration. If one or the other of torque magnitude and vibrational frequency is a fixed value, vibration input section 310a need only control the one that is not a fixed value.

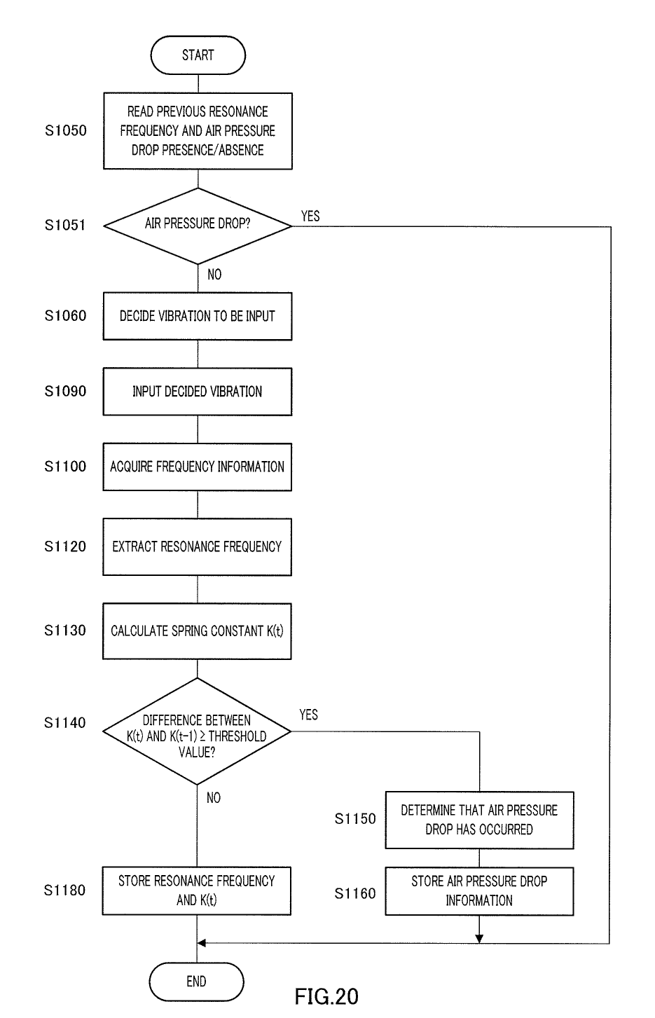

FIG. 20 is a flowchart showing an example of the operation of tire condition detection apparatus 10 according to Embodiment 4, corresponding to FIG. 17 of Embodiment 3.

Each time estimation execution timing arrives, vibration input section 310a reads resonance frequency f_{c0} and information on the presence or absence of an air pressure drop acquired at the previous estimation execution timing (hereinafter referred to simply as “(the) previous . . . ”), held in tire condition estimation section 330a (S1050).

In this information read, for example, provision may be made for vibration input section 310a to send an information request command to tire condition estimation section 330a, and for tire condition estimation section 330a, on acquiring this information request command, to send the information to vibration input section 310a. Then, if there is no air pressure drop (S1051: NO) vibration input section 310a decides resonance vibration for causing vibration including this resonance frequency f_{c0} to be generated (S1060), and inputs the decided resonance vibration to tire 108 (S1090). Details of the resonance frequency decision will be given later herein. If there is an air pressure drop (S1051: YES), vibration input section 310a terminates the processing without performing resonance vibration output.

On the other hand, when tire condition estimation section 330a calculates torsional spring constant K(t) (S1130), tire condition estimation section 330a determines whether or not the difference between torsional spring constant K(t) acquired at the present estimation execution timing (hereinafter referred to simply as “(the) present . . . ”) and previous torsional spring constant K(t−1) is greater than or equal to a predetermined threshold value (S1140). Here, t indicates that the parameter is based on the latest frequency information, and t-n indicates that the parameter is based on frequency information input at estimation execution timing n times before.

If the difference between present torsional spring constant K(t) and previous torsional spring constant K(t−1) is greater than or equal to the threshold value—that is, if tire internal pressure can be said to have changed sharply—(S1140: YES), tire condition estimation section 330a determines that a tire 108 air pressure drop has occurred (S1150). Then tire condition estimation section 330a stores air pressure drop information indicating that an air pressure drop has occurred (S1160).

This air pressure drop information is read by vibration input section 310a in step S1050 of the next estimation execution timing (hereinafter referred to simply as “(the) next . . . ”). Then vibration input section 310a stops resonance vibration output until reset processing is performed after a tire change or repair—that is, until air pressure drop information indicating no air pressure drop is input. This reset processing is directed by depression of a reset button or the like (not shown) by the driver or the like after a tire change has been performed. When reset processing is directed, tire condition estimation section 330a discards stored tire air pressure drop information.

If the difference is less than the threshold value (S1140: NO), tire condition estimation section 330a stores resonance frequency f_{c0} and spring constant K(t) (S1180). Of these, resonance frequency f_{c0} is read by vibration input section 310a in next step S1050, while spring constant K(t) is used as previous spring constant K(t−1) in next step S1140.

Tire condition estimation section 330a may also store spring constants K(t−1), K(t−2), . . . K(t-m) (where m is a positive integer) of a plurality of times. Then tire condition estimation section 330a uses the difference between any one, or the largest, or the average, of the stored plurality of spring constants and present spring constant K(t) in a determination.

Details of the above resonance frequency decision will now be given.

At a stage at which resonance frequency f_{c0} is unknown, vibration that facilitates the extraction of resonance frequency f_{c0} is also unknown. Therefore, vibration input section 310a decides resonance torque to be sinusoidal torque sweeping from a low frequency to a high frequency, or from a high frequency to a low frequency, in a wide frequency band. That is to say, in an initial state in which resonance frequency f_{c0} is unknown, vibration input section 310a decides upon vibratory torque involving searching a comparatively wide range as resonance torque in order to enable resonance frequency f_{c0} to be extracted dependably.

However, such a wide frequency band search is comparatively time-consuming.

Thus, if resonance frequency f_{c0} has been detected immediately before, tire condition detection apparatus 10 narrows down the search range to reduce the search time. Specifically, vibration input section 310a decides upon vibratory torque limited to a narrow frequency band that includes previous resonance frequency f_{c0} acquired from tire condition estimation section 330a as resonance torque.

For example, vibration input section 310a sets frequency upper-limit and lower-limit values in a range that includes previous resonance frequency f_{c0}, and decides upon sinusoidal torque sweeping from the lower-limit frequency to the upper-limit frequency, or from the upper-limit frequency to the lower-limit frequency, as resonance torque. Alternatively, vibration input section 310a creates a band-pass filter that limits a pass band to a range that includes previous resonance frequency f_{c0}, and vibration input section 310a intentionally causes white noise to be generated, and decides upon white noise torque obtained by passing this white noise through the generated band-pass filter as resonance torque.

Vibration input section 310a may also perform narrowing down of the search range only if there is little variation in resonance frequency f_{c0}. Also, vibration input section 310a may perform narrowing down of the search range using an average of resonance frequency f_{c0} values of a plurality of times. Furthermore, when performing calculation of this average, vibration input section 310a may exclude a greatly deviating value from the average calculation. By this means, tire condition detection apparatus 10 can improve the precision of resonance frequency f_{c0} extraction.

When an air pressure drop has occurred in tire 108 or tire 108 has been changed, the condition of tire 108 changes greatly, and therefore it is highly probable that resonance frequency f_{c0} has changed significantly. Therefore, in such cases, vibration input section 310a cancels the narrowing down of the search range, and decides upon vibratory torque involving searching a comparatively wide range as resonance torque.

Thus, tire condition detection apparatus 10 according to this Embodiment 4 enables the resonance frequency f_{c0} search time to be shortened. By this means, tire condition detection apparatus 10 according to Embodiment 4 can detect the condition of tire 108 in a short time.

### Embodiment 5

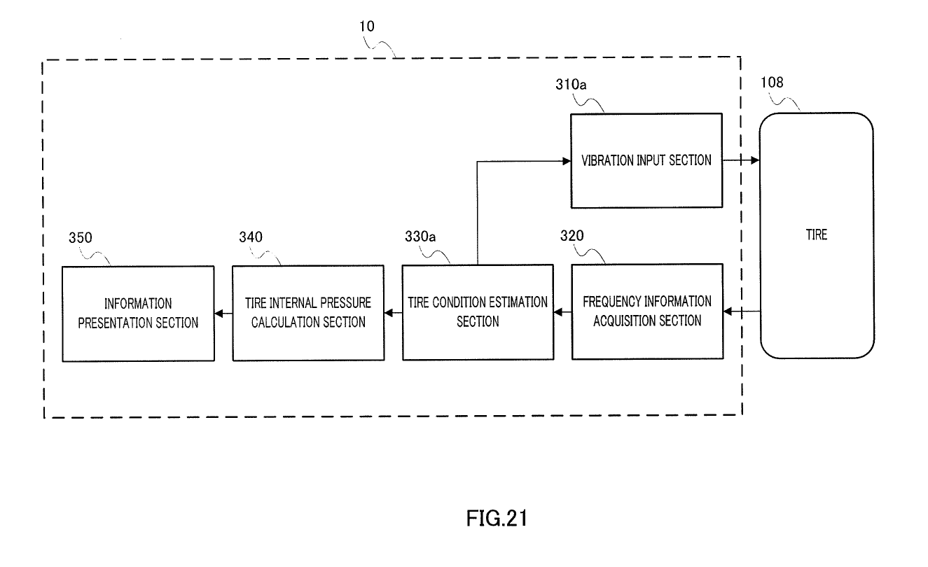

FIG. 21 is a block diagram showing an example of the configuration of a tire condition detection apparatus according to Embodiment 5 of the present invention, corresponding to FIG. 19 of Embodiment 4.

Tire condition detection apparatus 10 according to Embodiment 5 mainly differs from Embodiment 4 in having tire internal pressure calculation section 340 and information presentation section 350. Tire internal pressure calculation section 340 corresponds to internal pressure derivation section 110 of Embodiment 1 and Embodiment 2, and information presentation section 350 corresponds to information presentation section 111 of Embodiment 1 and Embodiment 2.

Tire internal pressure calculation section 340 acquires torsional spring constant K(t) from tire condition estimation section 330a, and calculates tire 108 internal pressure based on torsional spring constant K(t). Specifically, tire internal pressure calculation section 340, for example, stores a correlation between tire torsional spring constant K and tire 108 internal pressure beforehand, and calculates tire 108 internal pressure from torsional spring constant K(t) using this correlation. This correlation may be defined by means of a table, or may be defined by means of a function. Then tire internal pressure calculation section 340 outputs the calculated tire 108 internal pressure to information presentation section 350 as internal pressure information.

The correlation between torsional spring constant K and tire 108 internal pressure is a proportional relationship. Details of the proportional relationship between torsional spring constant K and tire 108 internal pressure, and a tire 108 internal pressure detection method based thereon, are given in Non-Patent Literature 1, for example, and therefore a description thereof is omitted here. However, the tire 108 internal pressure detection method used by tire internal pressure calculation section 340 is not limited to the method described in Non-Patent Literature 1.

If air pressure drop information is held in tire condition estimation section 330a, tire internal pressure calculation section 340 acquires this information and outputs it to information presentation section 350.

When internal pressure information or air pressure drop information is input from tire internal pressure calculation section 340, information presentation section 350 presents the contents of the internal pressure information or air pressure drop information to the driver. This presentation is performed, for example, by means of display on an instrument panel or car navigation apparatus display, or by means of speech output from a loudspeaker.

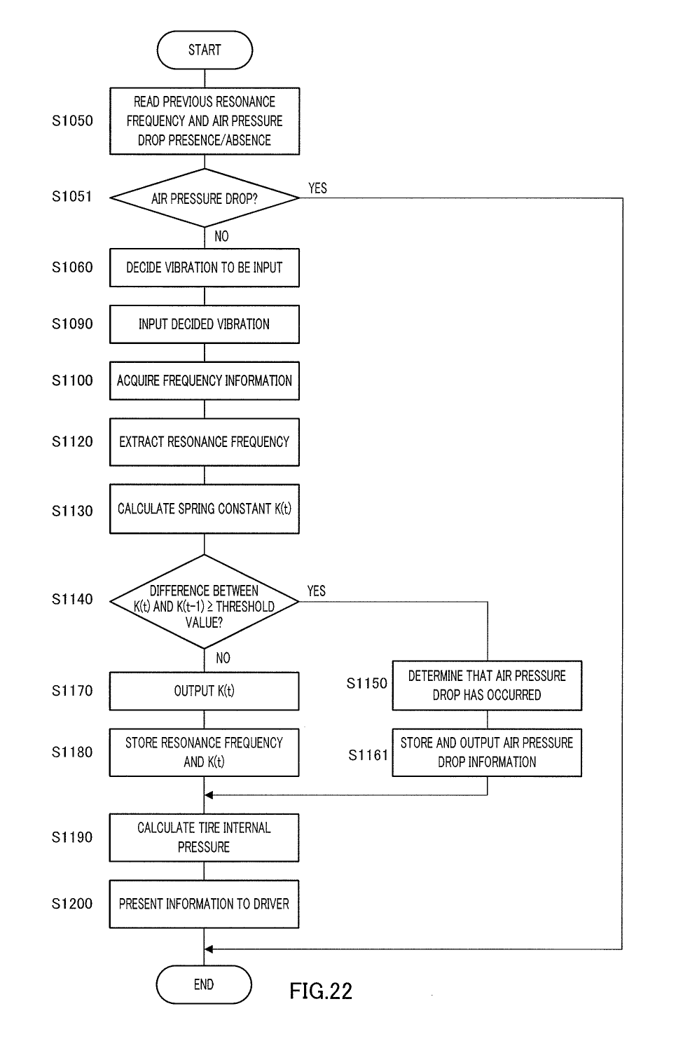

FIG. 22 is a flowchart showing an example of the operation of tire condition detection apparatus 10 according to Embodiment 5, corresponding to FIG. 20 of Embodiment 4.

When tire condition estimation section 330a determines that a tire 108 air pressure drop has occurred (S1150), tire condition estimation section 330a stores air pressure drop information and also outputs air pressure drop information to tire internal pressure calculation section 340 (S1161). If the difference between present torsional spring constant K(t) and previous torsional spring constant K(t−1) is less than a predetermined threshold value (S1140: NO), tire condition estimation section 330a outputs torsional spring constant K(t) to tire internal pressure calculation section 340 (S1170). Then tire condition estimation section 330a stores torsional spring constant K(t) (S1180).

When torsional spring constant K(t) is input, tire internal pressure calculation section 340 calculates tire 108 internal pressure from torsional spring constant K(t) (S1190). Then tire internal pressure calculation section 340 outputs the calculated internal pressure to information presentation section 350 as internal pressure information. Also, when air pressure drop information is input, tire internal pressure calculation section 340 outputs the fact that an air pressure drop has occurred in tire 108 to information presentation section 350. As a result, internal pressure information indicating tire 108 internal pressure, and air pressure drop information indicating that an air pressure drop has occurred in tire 108, are presented to the driver as appropriate according to the condition of tire 108 (S1200).

Thus, tire condition detection apparatus 10 according to Embodiment 5 presents the condition of tire 108 to the driver, enabling the driver to be prompted to take appropriate action such as inserting air or repairing a puncture. By this means, tire condition detection apparatus 10 according to Embodiment 5 enables vehicle safety and fuel consumption to be improved.

The object of information presentation is not limited to a driver, but may also be a passenger, a vehicle mechanic, or a remote observer of a vehicle. When presentation is performed for a mechanic, it is necessary for tire condition detection apparatus 10 to be provided with a recording medium that records internal pressure information and air pressure drop information, or information forming the basis of these. Also, when presentation is performed for a remote observer, it is necessary for tire condition detection apparatus 10 to be provided with a communication apparatus that transmits internal pressure information and air pressure drop information to an external apparatus such as an administrative server.

### Embodiment 6

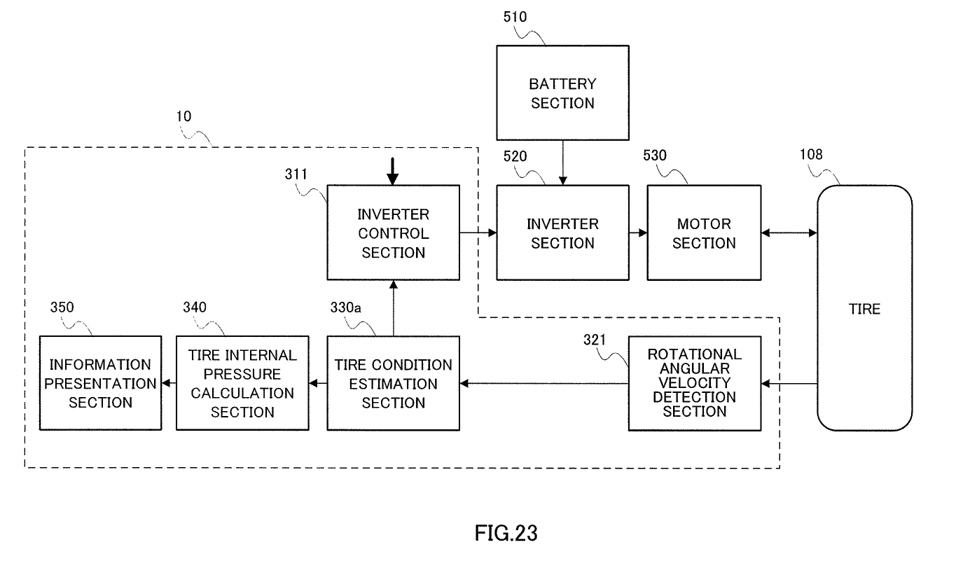

FIG. 23 is a block diagram showing an example of the configuration of a tire condition detection apparatus according to Embodiment 6 of the present invention, corresponding to FIG. 21 of Embodiment 5.

In tire condition detection apparatus 10 according to Embodiment 6, battery section 510, inverter section 520, and motor section 530 are applied to tire 108 as a drive system. Tire condition detection apparatus 10 according to Embodiment 6 mainly differs from Embodiment 5 in that vibration input section 310a is replaced by inverter control section 311, and frequency information acquisition section 320 is replaced by rotational angular velocity detection section 321. Battery section 510, inverter section 520, and motor section 530 correspond respectively to battery section 105, inverter section 104, and motor section 107/201 of Embodiment 1 and/or Embodiment 2. Inverter control section 311 and rotational angular velocity detection section 321 correspond respectively to inverter control section 103 and rotational angular velocity calculation section 203 of Embodiment 1 and/or Embodiment 2.

Battery section 510 is a storage battery that supplies inverter section 520 with power necessary for inverter section 520 to output a current.

Inverter section 520 outputs power to motor section 530 in accordance with a motor drive current output command value input from inverter control section 311 described later herein.

Motor section 530 generates torque by means of power supplied from inverter section 520, and drives tire 108.

Inverter control section 311 has operation information indicating a degree of depression of an accelerator pedal (for example, accelerator pedal 100 of Embodiment 1 and Embodiment 2) depressed by the driver in order to cause the vehicle to accelerate (hereinafter referred to simply as “operation information”) as input. This input is performed, for example, using accelerator position sensor section 101 of Embodiment 1 and Embodiment 2. Then inverter control section 311 decides a running torque value based on the operation information. Also, inverter control section 311 decides resonance torque in the same way as vibration input section 310a of Embodiment 5. Then inverter control section 311 outputs to inverter section 520 a motor drive current output command value such that combined torque comprising resonance torque and running torque is output from motor section 530.

Furthermore, inverter control section 311 detects an actual output value of a motor section 530 motor drive current by means of a current detection section (not shown). Then inverter control section 311 controls the inverter section 520 power supply to motor section 530 so that this actual output value matches an output command value calculated by inverter control section 311.

Inverter control section 311 may perform generation of such an output command value by extracting a combined torque value, or by combining (adding together) a resonance current and running current.

Rotational angular velocity detection section 321 detects rim rotational angular velocity ω₁ of tire 108 from tire 108, and outputs this to tire condition estimation section 330a as above-described frequency information. For example, rotational angular velocity detection section 321 acquires a rim rotational angular velocity from an encoder (not shown) that detects the rotation angle of a rotor relative to a stator of tire 108. Then rotational angular velocity detection section 321 calculates rotational angular velocity ω₁ by performing temporal differentiation on rim rotation angles.

Rotational angular velocity detection section 321 may acquire a rotation angle using, for example, an optical encoder such as an incremental encoder or absolute encoder, or an electromagnetic encoder comprising a Hall element or the like. Rotational angular velocity detection section 321 may also acquire a rotation angle or rotational angular velocity directly from tire 108.

Tire condition estimation section 330a calculates tire 108 resonance frequency f_{c0} based on rotational angular velocity ω₁ input from rotational angular velocity detection section 321.

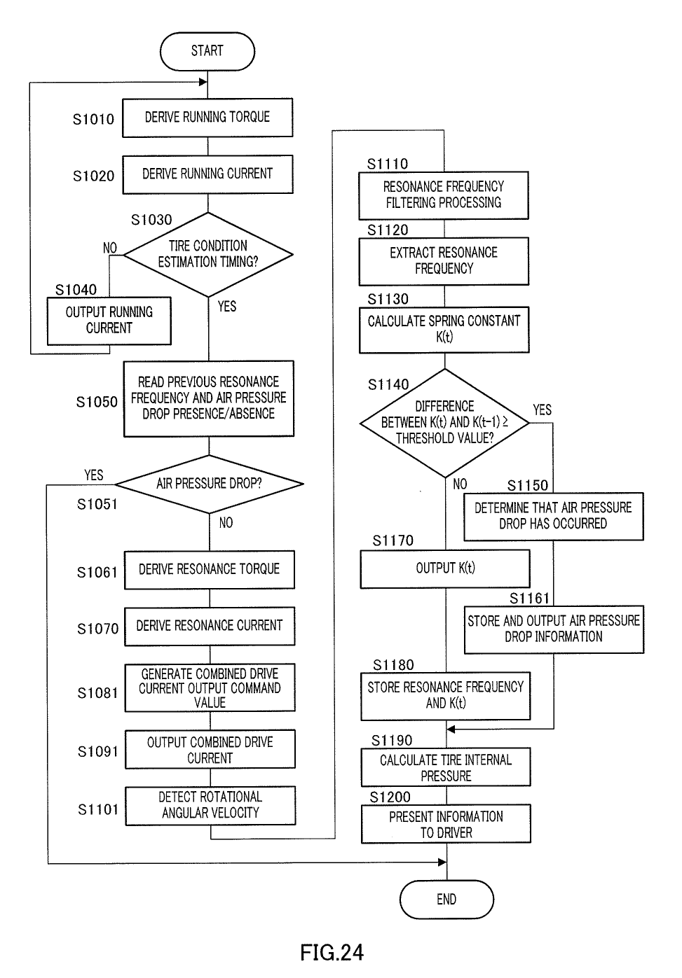

FIG. 24 is a flowchart showing an example of the operation of tire condition detection apparatus 10 according to Embodiment 6, corresponding to FIG. 22 of Embodiment 5.

First, when the accelerator pedal is depressed, inverter control section 311 derives a running torque value based on the degree of depression of the accelerator pedal (S1010), and derives a running current corresponding to the running torque value (S1020). Then, if this is not estimation execution timing (S1030: NO), inverter control section 311 outputs the running current to inverter section 520 as an output command value. As a result, only the running current is output from motor section 530 as a motor drive current (S1040), and only running torque is applied to tire 108.

On the other hand, if this is estimation execution timing (S1030: YES), inverter control section 311 reads previous resonance frequency f_{c0} (S1050). Then, if there is no air pressure drop (S1051: NO), inverter control section 311 derives resonance torque for causing vibration including previous resonance frequency f_{c0} to be generated (S1061). Then inverter control section 311 derives a resonance current corresponding to the resonance torque value (S1070), generates an output command value of a combined drive current in which a running current and resonance current are superposed, and outputs this combined drive current output command value to inverter section 520 (S1081). As a result, a combined drive current is output from motor section 530 as a motor drive current (S1091), and combined drive torque is applied to tire 108.

Then rotational angular velocity detection section 321 detects tire 108 rotational angular velocity ω₁, and outputs this to tire condition estimation section 330a as a time series rotational angular velocity signal (S1101). Tire condition estimation section 330a passes the input rotational angular velocity signal through an above-described band-pass filter that takes a band including resonance frequency f_{c0} as a pass band (S1110). Then tire 108 resonance frequency f_{c0} is extracted from the rotational angular velocity signal that has passed through the band-pass filter (S1120).

Thus, tire condition detection apparatus 10 according to Embodiment 6 has operation information as input, and performs input of running torque and resonance torque by controlling the motor drive current value. By this means, tire condition detection apparatus 10 according to Embodiment 6 can easily input resonance vibration to tire 108 of a drive system capable of acquiring operation information and capable of specifying a motor drive current value.

Also, tire condition detection apparatus 10 according to Embodiment 6 inputs resonance vibration from motor section 530 connected to tire 108 in a stable and fixed manner, enabling the effects of a resonance frequency in frequency information and a vibration component other than a resonance frequency to be reduced.

Furthermore, tire condition detection apparatus 10 according to Embodiment 6 acquires rotational angular velocity acquired from a rotational angular velocity sensor installed in order to drive motor section 530 as frequency information, making the provision of a separate sensor for detecting vibration unnecessary.

When a vehicle is stopped, the driver is not depressing the accelerator pedal, and running torque is zero. Therefore, if tire condition detection apparatus 10 performs detection of the condition of tire 108 while the vehicle is stopped, only resonance torque is input to tire 108.

### Embodiment 7

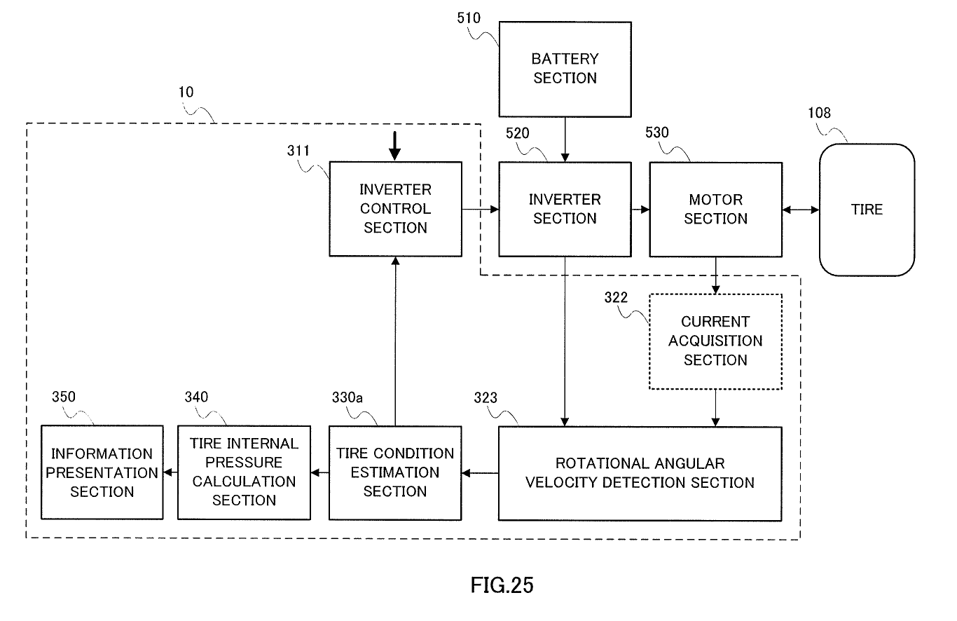

FIG. 25 is a block diagram showing an example of the configuration of a tire condition detection apparatus according to Embodiment 7 of the present invention, corresponding to FIG. 23 of Embodiment 6.

Tire condition detection apparatus 10 according to Embodiment 7 mainly differs from Embodiment 6 in that rotational angular velocity detection section 321 is replaced by current acquisition section 322 and rotational angular velocity detection section 323.

Current acquisition section 322 acquires an actual output value of a motor drive current from motor section 530, and outputs this motor drive current actual output value to rotational angular velocity detection section 323.

Rotational angular velocity detection section 323 calculates tire 108 rim rotational angular velocity ω₁ from motor drive current actual output value I_{q}, and outputs this rotational angular velocity ω₁ to tire condition estimation section 330a.

The method of calculating tire 108 rotational angular velocity ω₁ from motor drive current actual output value I_{q} in rotational angular velocity detection section 323 will now be described.

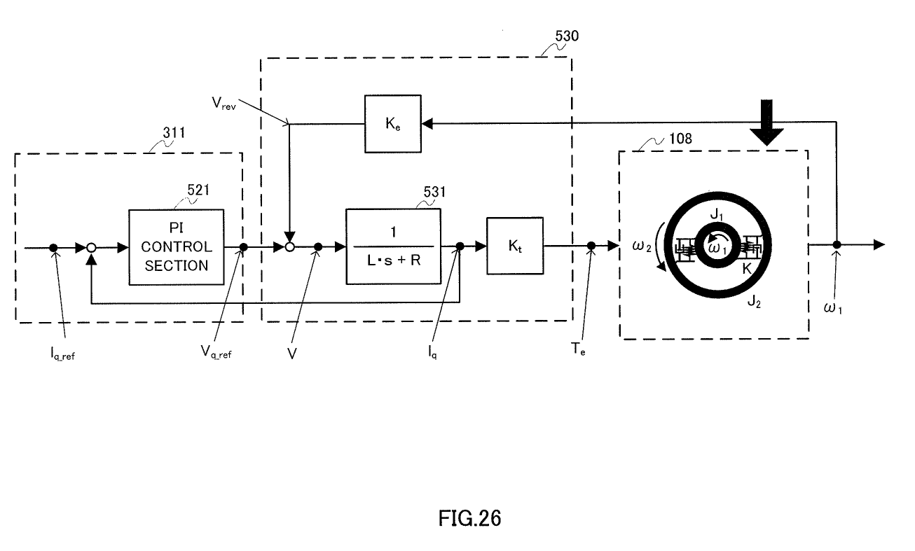

FIG. 26 is a control block diagram showing an example of the configuration of a motor drive system.

PI controller 521 of inverter control section 311 is a controller that controls actual output value I_{q} of a current flowing through motor section 530 so that a combined drive current actual output value detected by motor section 530 matches a combined drive current (command value) calculated by inverter control section 311. That is to say, PI controller 521 applies control voltage V_{q}_{_{—}}_{ref} such that motor section 530 actual output value I_{q} matches output command value I_{q}_{_{—}}_{ref} calculated by inverter control section 311 to motor section 530.

Motor circuit 531 is an electronic circuit that can be modeled by means of wound coil inductance L and wound coil resistance R. By means of actual output value I_{q}, output torque Tₑ proportional to torque constant Kₜ is applied to tire 108. Then the rotor of motor section 530 rotates at rotational angular velocity ω₁ together with the rotation of tire 108. At this time, (proportional constant Ke) counter electromotive force—Keω₁ proportional to rotor rotational angular velocity ω₁ is generated in motor section 530, and voltage V=V_{q}_{_{—}}_{ref}-Keω₁ is input to both ends of the wound coil of motor section 530 as an actual input voltage value. Equation 2 below is derived from this relationship.

$$\begin{matrix}( Equation 2 ) & \\ {\hat{ω}}_{1} = \frac{1}{{K}_{e}} ( {V}_{q \_ ref} - V ) = \frac{1}{{K}_{e}} ( {V}_{q \_ ref} - L {\dot{I}}_{q} - {RI}_{q} ) & [ 2 ]\end{matrix}$$

Rotational angular velocity detection section 323 calculates motor section 530 rotational angular velocity (that is, tire 108 rim rotational angular velocity) ω₁ from actual output value I_{q} and control voltage V_{q}_{_{—}}_{ref} using equation 2, and outputs this rotational angular velocity ω₁ to tire condition estimation section 330a.

Thus, tire condition detection apparatus 10 according to Embodiment 7 can detect rotational angular velocity ω₁ from an actual output value of a drive current output to motor section 530 and a control voltage calculated by inverter control section 311, enabling an encoder or suchlike sensor to be made unnecessary.

In Embodiment 7, motor section 530 is a synchronous motor with a surface magnet structure in which a permanent magnet is attached to the surface of the rotor, and current control in which the d-axis current is zero is assumed, but the configuration of motor section 530 is not limited to this. For example, it is possible to detect rotational angular velocity ω₁ in a similar way in a case in which motor section 530 is a synchronous motor with an embedded magnet structure in which a permanent magnet is embedded within the rotor, and a current control system in which the d-axis current is non-zero is assumed.

### Embodiment 8

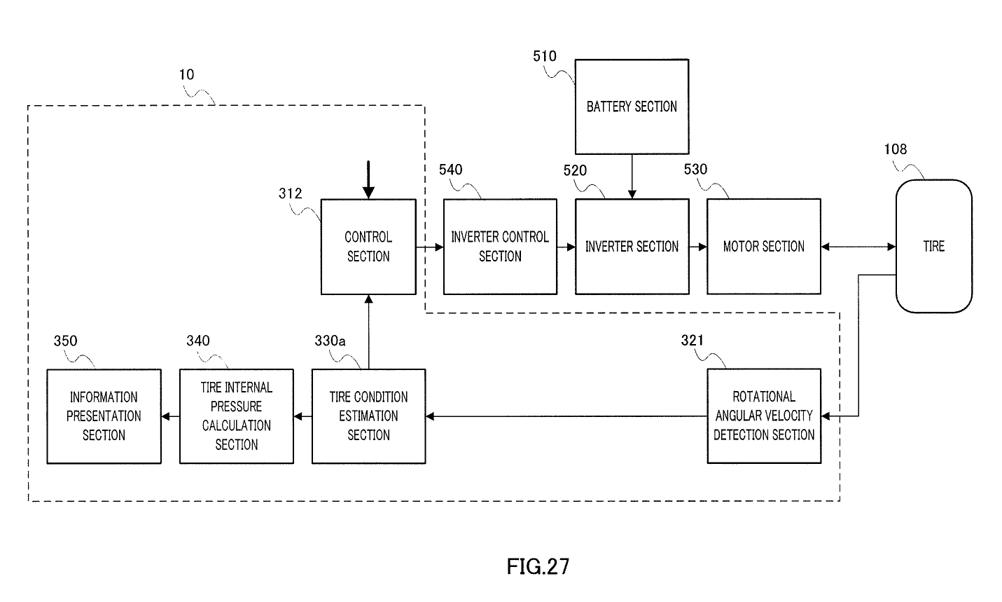

FIG. 27 is a block diagram showing an example of the configuration of a tire condition detection apparatus according to Embodiment 8 of the present invention, corresponding to FIG. 23 of Embodiment 6.

In tire condition detection apparatus 10 according to Embodiment 8, battery section 510, inverter section 520, motor section 530, and inverter control section 540 are applied to tire 108 as a drive system. Tire condition detection apparatus 10 according to Embodiment 8 mainly differs from Embodiment 6 in that inverter control section 311 is replaced by control section 312. Control section 312 corresponds to ECU 102 of Embodiment 1 and Embodiment 2.

Based on a tire 108 output torque value input from control section 312 described later herein, inverter control section 540 calculates a motor drive current output command value such that that output torque is output by motor section 530, and outputs this motor drive current output command value to inverter section 520. Alternatively, based on a motor drive current such that tire 108 output torque is output by motor section 530, input from control section 312 described later herein, inverter control section 540 calculates an output command value to output that motor drive current, and outputs this output command value to inverter section 520.

In the same way as vibration input section 310a described in Embodiment 5, control section 312 decides a running torque value and a resonance torque value based on operation information. Then control section 312 outputs a value of combined torque combining resonance torque and running torque to inverter control section 540 as a tire 108 output torque value. Output of an output torque value may be performed by means of motor drive current output to motor section 530 for outputting output torque to tire 108, rather than an output torque value itself.

Thus, tire condition detection apparatus 10 according to Embodiment 8 has operation information as input, and performs input of running torque and resonance torque by controlling the output torque value. By this means, tire condition detection apparatus 10 according to Embodiment 8 can easily input resonance vibration to tire 108 of a drive system capable of acquiring operation information and capable of specifying an output torque value.

### Embodiment 9

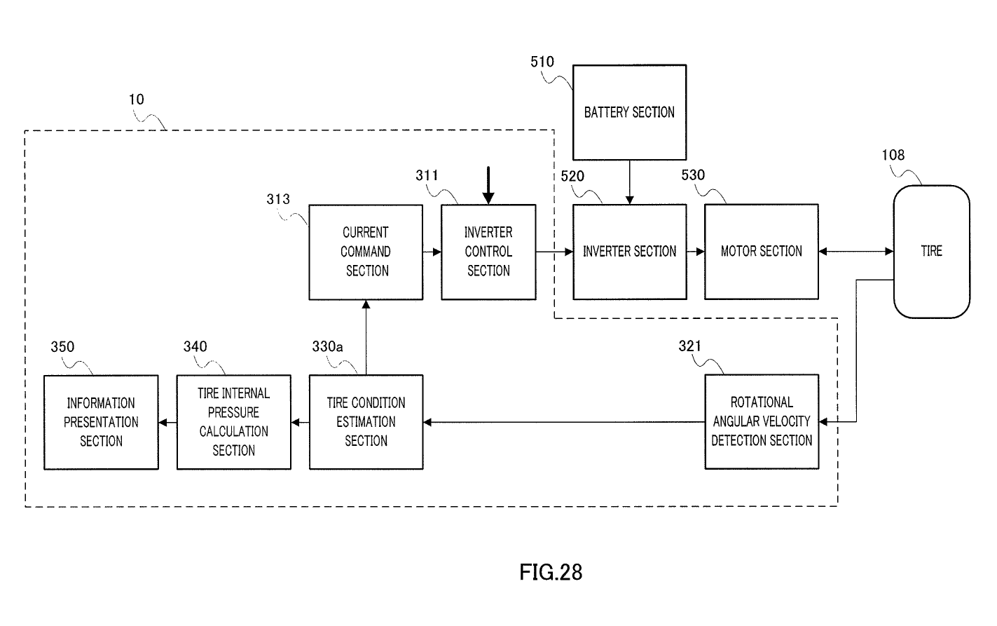

FIG. 28 is a block diagram showing an example of the configuration of a tire condition detection apparatus according to Embodiment 9 of the present invention, corresponding to FIG. 23 of Embodiment 6.

Tire condition detection apparatus 10 according to Embodiment 9 mainly differs from Embodiment 6 in having current command section 313.

Control section 312 corresponds to ECU 102 of Embodiment 1 and Embodiment 2.

Current command section 313 decides resonance torque in the same way as inverter control section 311 of Embodiment 6. Then current command section 313 outputs a motor drive current value such that the decided resonance torque is output by motor section 530, to inverter control section 311 as a resonance current value.

Inverter control section 311 decides a running torque value corresponding to a degree of depression of the accelerator pedal, and calculates a running current value such that this running torque is output by motor section 530. Then inverter control section 311 calculates a combined drive current value by adding the resonance current value input from current command section 313 to the running current value, and outputs the result of this calculation to inverter section 520 as an output command value.

Thus, by having current command section 313 that generates a resonance current that causes a natural resonance of tire 108 to be generated, tire condition detection apparatus 10 according to Embodiment 9 outputs a combined drive current superposed on a running current to motor section 530, and performs input of running torque and resonance torque. By this means, tire condition detection apparatus 10 according to Embodiment 9 can easily input resonance vibration to tire 108.

### Embodiment 10

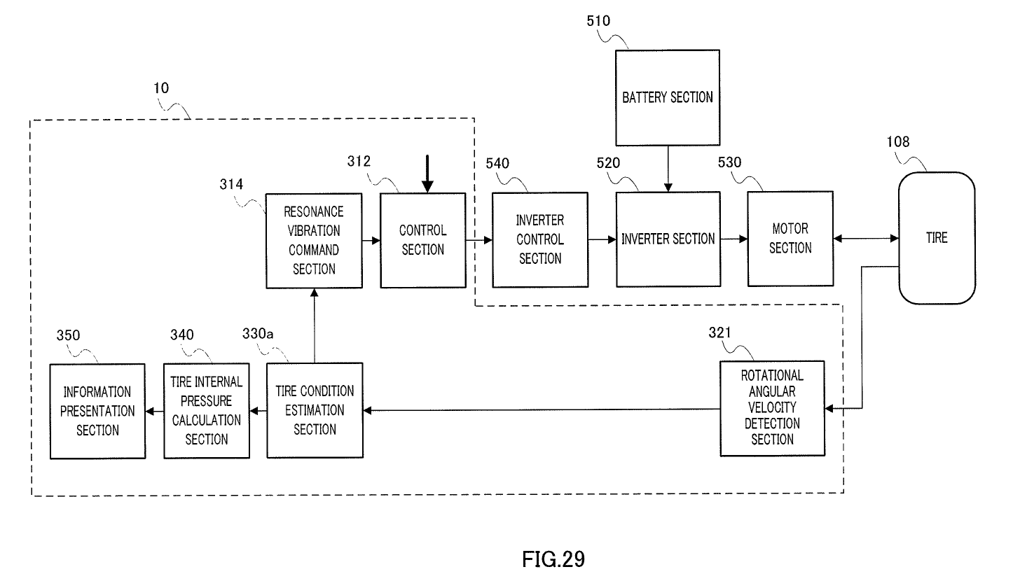

FIG. 29 is a block diagram showing an example of the configuration of a tire condition detection apparatus according to Embodiment 10 of the present invention, corresponding to FIG. 27 of Embodiment 8.

Tire condition detection apparatus 10 according to Embodiment 10 mainly differs from Embodiment 8 in having resonance vibration command section 314. Resonance vibration command section 314 corresponds to ECU 102 of Embodiment 1 and Embodiment 2.

Resonance vibration command section 314 decides resonance torque in the same way as current command section 313 of Embodiment 9. Then resonance vibration command section 314 outputs the decided resonance torque value to control section 312.

Control section 312 decides running torque corresponding to a degree of depression of an accelerator pedal (not shown) depressed by the driver in order to cause the vehicle to accelerate. Then control section 312 calculates combined torque comprising resonance torque input from resonance vibration command section 314 and running torque, and outputs this combined torque to inverter control section 540. Alternatively, control section 312 derives a motor drive current (that is, running current) value such that this running torque is output from motor section 530, and control section 312 also derives a motor drive current (that is, resonance current) such that resonance torque input from resonance vibration command section 314 is output by motor section 530, generates a combined drive current in which the resonance current is superposed on the running current, and outputs this combined drive current to inverter control section 540.

Thus, by having resonance vibration command section 314 that generates resonance torque that causes natural vibration to be generated in tire 108, tire condition detection apparatus 10 according to Embodiment 10 outputs a combined drive current based on combined torque superposed with running torque to motor section 530, and performs input of running torque and resonance torque. By this means, tire condition detection apparatus 10 according to Embodiment 10 can easily input resonance vibration to tire 108 of a drive system capable of specifying a motor drive current value for tire 108.

### Embodiment 11

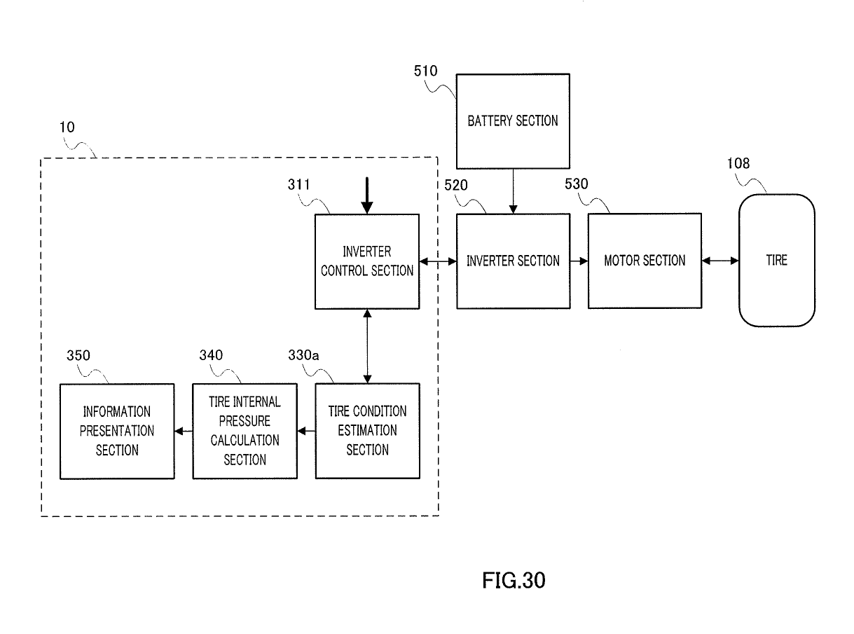

FIG. 30 is a block diagram showing an example of the configuration of a tire condition detection apparatus according to Embodiment 11 of the present invention, corresponding to FIG. 23 of Embodiment 6.

Tire condition detection apparatus 10 according to Embodiment 11 mainly differs from Embodiment 6 in that rotational angular velocity detection section 321 is not provided.

Tire condition estimation section 330a has control voltage V_{q}_{_{—}}_{ref} for motor section 530 in FIG. 26 calculated by inverter control section 311 as input, calculates resonance frequency fₐ, by means of the method below, for example, and estimates the condition of tire 108.

Equation 3 below is derived from the relationship illustrated in FIG. 26.

[3]

V_{g}_{_{—}}_{ref}=Kₑ\hat{ω}₁+V=Kₑ\hat{ω}₁+(Lİ_{q}+RI_{q}) (Equation 3)

In this equation 3, the right-hand second term+third term (I_{q} terms) are controlled so that motor section 530 outputs motor drive current output command value I_{q}_{_{—}}_{ref} input from inverter control section 311, and therefore the same frequency characteristic as for input output-command-value I_{g}_{_{—}}_{ref} appears. On the other hand, the right-hand first term (Keω₁ term) is a countercurrent generated according to vibration that includes resonance frequency f_{c0} as illustrated in equation 1. Therefore, by using control voltage V_{q}_{_{—}}_{ref} of equation 3, it is possible to detect torsional spring resonance frequency f_{c0} that is affected by tire internal pressure.

Resonance frequency f_{c0} can be detected from control voltage V_{q}_{_{—}}_{ref} by performing above-mentioned frequency analysis on control voltage V_{q}_{_{—}}_{ref} and detecting a sharp peak position indicating resonance frequency f_{c0}, or by utilizing the above-mentioned batch least-squares estimation method.

Thus, tire condition detection apparatus 10 according to Embodiment 11 estimates the condition of tire 108 from a control voltage for motor section 530, enabling a rotational angular velocity acquisition section to be made unnecessary. That is to say, without using a sensor that detects the angle or rotational angular velocity of tire 108, tire condition detection apparatus 10 according to Embodiment 11 can detect the condition of tire 108 with a precision equivalent to that of a configuration that uses such a sensor.

Tire condition detection apparatuses according to Embodiment 6 through Embodiment 11 have been assumed to control an input signal to an inverter section as a method of inputting predetermined vibration to a tire, but an input signal (that is, a control voltage) to a motor section may also be controlled directly. That is to say, a tire condition detection apparatus may have a configuration that includes an inverter section.

Tire condition detection apparatuses according to Embodiment 6 through Embodiment 11 need not necessarily be provided with a tire internal pressure calculation section and an information presentation section.

Tire condition detection apparatuses according to Embodiment 8 through Embodiment 10 may be provided with a current acquisition section and rotational angular velocity detection section of Embodiment 7 instead of a rotational angular velocity acquisition section.

Tire condition detection apparatuses according to Embodiment 8 through Embodiment 10 need not necessarily be provided with a rotational angular velocity acquisition section, and may extract a resonance frequency from a control voltage as described in Embodiment 11.

The disclosure of Japanese Patent Application No. 2009-228279, filed on Sep. 30, 2009, including the specification, drawings and abstract, is incorporated herein by reference in its entirety.

### INDUSTRIAL APPLICABILITY

A tire condition detection apparatus according to the present invention is suitable for use as a tire condition detection apparatus and tire condition detection method enabling tire condition to be detected with a high degree of precision, and is particularly suitable for use as an apparatus used in part of a motor vehicle, railway vehicle, or the like.

### REFERENCE SIGNS LIST

1, 2 Vehicle
10, 20 Tire condition detection apparatus
100 Accelerator pedal
101 Accelerator position sensor section
102 ECU
103, 311, 540 Inverter control section
104, 520 Inverter section
105, 510 Battery section
106 Current detection section
107, 201, 530 Motor section
108 Tire
109 Resonance frequency detection section
110 Internal pressure derivation section
111, 350 Information presentation section
202 Encoder section
203 Rotational angular velocity calculation section
310, 310a Vibration input section
312 Control section
313 Current command section
314 Resonance vibration command section
320 Frequency information acquisition section
321, 323 Rotational angular velocity detection section
322 Current acquisition section
330, 330a Tire condition estimation section
340 Tire internal pressure calculation section
521 PI controller
531 Motor circuit

1-11. (canceled)

12. A tire condition detection apparatus that detects a tire condition of a pneumatic tire fixed to a wheel driven by a drive system that includes a motor and an inverter that supplies a current to the motor, the tire condition detection apparatus comprising:
a vibration input section that inputs predetermined vibration to the tire by controlling a control voltage applied to the motor by the inverter so that the predetermined vibration is generated from the motor;
a frequency information acquisition section that acquires frequency information of the tire when the predetermined vibration is input; and
a tire condition estimation section that extracts a resonance frequency of the tire from the frequency information acquired, and calculates a spring constant when the tire is modeled based on an outer moment of inertia, an inner moment of inertia, and the spring constant of elastic force acting therebetween, from the tire resonance frequency acquired.

13. A tire condition detection apparatus that detects a tire condition of a pneumatic tire fixed to a wheel driven by a drive system that includes a motor and an inverter that supplies a current to the motor, the tire condition detection apparatus comprising:
a vibration input section that causes predetermined vibration to be generated in the tire by the inverter outputting a combined drive current in which a running current for rotation of the tire and a resonance current for the predetermined vibration are superposed to the motor;
a frequency information acquisition section that acquires frequency information of the tire when the predetermined vibration is input; and
a tire condition estimation section that extracts a resonance frequency of the tire from the frequency information acquired, and calculates a spring constant when the tire is modeled based on an outer moment of inertia, an inner moment of inertia, and the spring constant of elastic force acting therebetween, from the tire resonance frequency acquired.

14. The tire condition detection apparatus according to claim 12, wherein the tire condition estimation section detects an occurrence of an air pressure drop of the tire from a change in the spring constant.

15. The tire condition detection apparatus according to claim 13, wherein the tire condition estimation section detects an occurrence of an air pressure drop of the tire from a change in the spring constant.

16. The tire condition detection apparatus according to claim 12, wherein the frequency information acquisition section acquires rotational angular velocity of the tire as the frequency information.

17. The tire condition detection apparatus according to claim 13, wherein the frequency information acquisition section acquires rotational angular velocity of the tire as the frequency information.

18. The tire condition detection apparatus according to claim 14, wherein the vibration input section, when the occurrence of an air pressure drop is detected and when a previously extracted resonance frequency of the tire does not exist, decides upon a first frequency band as a frequency of the predetermined vibration, and when the occurrence of an air pressure drop has not been detected and the previously extracted resonance frequency of the tire exists, decides upon a second frequency band that includes the previously extracted resonance frequency of the tire and is narrower than the first frequency band as a frequency of the predetermined vibration.

19. The tire condition detection apparatus according to claim 15, wherein the vibration input section, when the occurrence of an air pressure drop is detected and when a previously extracted resonance frequency of the tire does not exist, decides upon a first frequency band as a frequency of the predetermined vibration, and when the occurrence of an air pressure drop has not been detected and the previously extracted resonance frequency of the tire exists, decides upon a second frequency band that includes the previously extracted resonance frequency of the tire and is narrower than the first frequency band as a frequency of the predetermined vibration.

20. The tire condition detection apparatus according to claim 14, further comprising:
a tire internal pressure calculation section that calculates internal pressure of the tire from the calculated spring constant; and
an information presentation section that presents at least one of the internal pressure calculated, and the detected occurrence of an air pressure drop.

21. The tire condition detection apparatus according to claim 15, further comprising:
a tire internal pressure calculation section that calculates internal pressure of the tire from the calculated spring constant; and
an information presentation section that presents at least one of the internal pressure calculated, and the detected occurrence of an air pressure drop.

22. The tire condition detection apparatus according to claim 16, wherein the frequency information acquisition section acquires the rotational angular velocity from a drive current that is supplied by the inverter in order to drive the motor, and the control voltage that is applied to a motor in order to supply a drive current.

23. The tire condition detection apparatus according to claim 17, wherein the frequency information acquisition section acquires the rotational angular velocity from a drive current that is supplied by the inverter in order to drive the motor, and the control voltage that is applied to a motor in order to supply a drive current.

24. The tire condition detection apparatus according to claim 12, wherein the vibration input section calculates directive information for directing the inverter that supplies current to the motor to perform control to generate the predetermined vibration from the motor.

25. The tire condition detection apparatus according to claim 13, wherein the vibration input section calculates directive information for directing the inverter that supplies current to the motor to perform control to generate the predetermined vibration from the motor.

26. The tire condition detection apparatus according to claim 12, wherein:
the wheel is a wheel driven by a motor;
the vibration input section controls a control voltage for the motor of an inverter that supplies a current to the motor so that the predetermined vibration is generated from the motor; and
the frequency information acquisition section acquires the control voltage as the frequency information.

27. The tire condition detection apparatus according to claim 13, wherein:
the wheel is a wheel driven by a motor;
the vibration input section controls a control voltage for the motor of an inverter that supplies a current to the motor so that the predetermined vibration is generated from the motor; and
the frequency information acquisition section acquires the control voltage as the frequency information.

28. A tire condition detection method for detecting a tire condition of a pneumatic tire fixed to a wheel driven by a drive system that includes a motor and an inverter that supplies a current to the motor, wherein:
a vibration input section inputs predetermined vibration to the tire by controlling a control voltage applied to the motor by the inverter so that the predetermined vibration is generated from the motor;
a frequency information acquisition section acquires frequency information of the tire when the predetermined vibration is input; and
a tire condition estimation section extracts a resonance frequency of the tire from the frequency information acquired, and calculates a spring constant when the tire is modeled based on an outer moment of inertia, an inner moment of inertia, and the spring constant of elastic force acting therebetween, from the tire resonance frequency acquired.
